(19) United States
(12) Patent Application Publication
(10) Pub. No.: US 2026/0250955 A1
(43) Pub. Date: Aug. 27, 2026

(54) Sandwich panel and building envelope thereof

(71) Applicant: ArcelorMittal, Luxembourg (LU)

(72) Inventors: Olivier BEGUE, Brillon-En-Barrois (FR); Renaud VIGNAL, SEVRIER (FR); Mederic DESCAZEAUX, Bar-Le-Duc (FR)

(21) Appl. No.: 19/158,052

(22) PCT Filed: Dec. 12, 2023
(86) PCT No.: PCT/IB2023/062534

§ 371 Date: Aug. 20, 2025

(30) Foreign Application Priority Data
Feb. 23, 2023 (WO) PCT/IB2023/051681

(51) Int. Cl. E04D 3/40; E04D 3/35; E04D 3/362; H02S 20/23; H02S 40/36

(52) U.S. Cl. CPC E04D 3/40; E04D 3/352; E04D 3/362; H02S 20/23; H02S 40/36

(57) ABSTRACT

A sandwich panel including a photovoltaic active area positioned on the outer sheet and whose upper, respectively lower, electrical connector is positioned in an upper, respectively lower, cavity, the upper cavity being positioned within the insulation material in the upper half of the sandwich panel and adjacent to either the second longitudinal side of the insulation material or the inner sheet so that the upper electrical connector can be accessed from the upper cavity, the lower cavity being positioned within the insulation material in the lower half of the sandwich panel and adjacent to either the second longitudinal side of the insulation material or the inner sheet so that the first lower electrical connector can be accessed from the lower cavity.

The present invention relates to a sandwich panel intended for the construction of building envelopes, and more particularly intended for the construction of building roofs, walls, facades and claddings, without being limited thereto. In particular, the invention relates to a building integrated photovoltaic (BIPV) sandwich panel.

### BACKGROUND

Roof coverings are known to be made of sandwich panels comprising an inner sheet, an outer sheet and an insulation material sandwiched between the inner sheet and the outer sheet. Both sheets are usually made of metal and the insulation material is usually polyurethane (PUR) foam, polyisocyanurate (PIR) foam or mineral wool.

### SUMMARY OF THE INVENTION

It is known from WO2012/120489 to laminate together the different layers of a photovoltaic solar collector unit, on a sandwich panel, via pressure exerted by a roll and by heat supplied by a temperature chamber as illustrated in FIG. 8 of this patent. During this process, the films surrounding the solar cells fuse and embed them in the collector unit. Nevertheless, the temperatures reached during the lamination of the photovoltaic solar collector unit on a sandwich panel damage the insulation material of the sandwich panel, jeopardizing the adhesion between the insulation materials and the metallic sheets.

Meanwhile, improvements in the way the photovoltaic function is integrated in the sandwich panel should neither jeopardize the manufacturing process of sandwich panels in existing production facilities nor impair other functions of the sandwich panel.

It is an object of the present invention to remedy the drawbacks of the prior art by providing a building integrated photovoltaic sandwich panel with improved photovoltaic integration while keeping the process for manufacturing sandwich panels substantially unchanged.

For this purpose, a first subject of the present invention provides a sandwich panel, for building envelope, comprising an inner sheet, an outer sheet and an insulation material sandwiched between the inner sheet and the outer sheet, the insulation material having a first longitudinal side, a second longitudinal side, an upper transverse side and a lower transverse side, the sandwich panel having an upper half and a lower half,
the outer sheet comprising:
a first longitudinal outer flange including a first longitudinal rib projecting from the first longitudinal side of the insulation material,
an outer central part extending from the first longitudinal rib, including:
   a first upper perforation through which a first upper electrical conductor runs,
   a first lower perforation through which a first lower electrical conductor runs,
a first photovoltaic active area positioned on the outer central part and electrically connected to the first upper electrical conductor and to the first lower electrical conductor,
a second longitudinal outer flange extending from the outer central part and comprising a second longitudinal rib, the first longitudinal rib and the second longitudinal rib having shapes that allow the overlapping of the first longitudinal rib on the second longitudinal rib,
the backside of the outer sheet comprising:
a first upper cable connecting the first upper electrical conductor to a first upper electrical connector positioned in an upper cavity,
a first lower cable connecting the first lower electrical conductor to a first lower electrical connector positioned in a lower cavity, the first lower electrical connector and the first upper electrical connector being corresponding male and female connectors,
the upper cavity being positioned within the insulation material in the upper half of the sandwich panel and adjacent to either the second longitudinal side of the insulation material or the inner sheet so that the first upper electrical connector can be accessed from the upper cavity,
the lower cavity being positioned within the insulation material in the lower half of the sandwich panel and adjacent to either the second longitudinal side of the insulation material or the inner sheet so that the first lower electrical connector can be accessed from the lower cavity.

The first subject of the present invention may also have the optional features listed below, considered individually or in combination:
the outer sheet further comprises an upper transverse outer edge bordering an upper overlap area,
the outer sheet further comprises a lower transverse outer edge extending beyond the lower transverse side of the insulation material to form a lower overlap area, the upper overlap area and the lower overlap area having shapes that allow the overlapping of the lower overlap area on the upper overlap area,
the electrical conductors are conductive ribbons,
the first photovoltaic active area covers the first upper perforation and the first lower perforation,
a first upper junction box connects the first upper conductive ribbon to the first upper cable running from the first upper junction box to the first upper electrical connector positioned in the upper cavity,
a first lower junction box connects the first lower electrical conductor to the first lower cable running from the first lower junction box to the first lower electrical connector positioned in the lower cavity,
the upper cavity is open along the second longitudinal side of the insulation material and/or along the upper transverse side of the insulation material and/or along the inner sheet,
the lower cavity is open along the second longitudinal side of the insulation material and/or along the lower transverse side of the insulation material and/or along the inner sheet,
the upper cavity is open along the second longitudinal side of the insulation material through a cut in the insulation material and/or through a cut in an edge band covering the second longitudinal side and/or through a cut in a wall of the upper cavity,
the second longitudinal side of the insulation material comprises an upper cutout extending from the upper cavity to the upper transverse side of the insulation material,
the upper cavity is open along the inner sheet through an upper hole in the inner sheet,
the inner sheet comprises an upper groove extending from the upper cavity to the upper transverse side of the insulation material,
the lower cavity is open along the second longitudinal side of the insulation material through a cut in the insulation material and/or through a cut in an edge band covering the second longitudinal side and/or through a cut in a wall of the lower cavity,
the second longitudinal side of the insulation material comprises a lower cutout extending from the lower cavity to the lower transverse side of the insulation material,
the lower cavity is open along the inner sheet through a lower hole in the inner sheet,
the inner sheet comprises a lower groove extending from the lower cavity to the lower transverse side of the insulation material,
each of the upper cavity and the lower cavity is delimited by a casing embedded in the insulation material,
the casing is made of a foamed material,
the casing comprises an inlet for cable insertion and an outlet for accessing the first upper electrical connector or the first lower electrical connector,
the upper cavity and the lower cavity each have a wall in the plane of the second longitudinal side of the insulation material,
the upper cavity and the lower cavity are in contact with the inner sheet,
the upper cavity comprises a portion of the first upper cable and the lower cavity comprises a portion of the first lower cable,
the portion of the first upper cable is folded in the upper cavity and the portion of the first lower cable is folded in the lower cavity,
the inner sheet comprises:
   An inner central part substantially lying in a plane P,
   A first longitudinal inner flange extending inwards from a first longitudinal extremity of the inner central part and forming an inner edge rabbet in the insulation material along its first longitudinal side,
   A second longitudinal inner flange extending from a second longitudinal extremity of the inner central part by projecting from the second longitudinal side of the insulation material and forming an inner tongue extending in parallel to plane P and outwards, the inner edge rabbet and the inner tongue having shapes that allow their interlocking,
the outer central part further includes:
   a second upper perforation through which a second upper electrical conductor runs,
   a second lower perforation through which a second lower electrical conductor runs,
the outer sheet further comprises a second photovoltaic active area positioned on the outer central part and electrically connected to the second upper electrical conductor and to the second lower electrical conductor,
the second photovoltaic active area covers the second upper perforation and the second lower perforation,
the backside of the outer sheet further comprises:
   a second upper cable connecting the second upper electrical conductor to a second upper electrical connector positioned in the upper cavity,
   a second lower cable connecting the second lower electrical conductor to a second lower electrical connector positioned in the lower cavity, the second lower electrical connector and second upper electrical connector being corresponding male and female connectors,
a second upper junction box connects the second upper conductive ribbon to the second upper cable running from the second upper junction box to the second upper electrical connector positioned in the upper cavity,
a second lower junction box connects the second lower electrical conductor to the second lower cable running from the second lower junction box to the second lower electrical connector positioned in the lower cavity,
the first photovoltaic active area and the second photovoltaic active area extend in the longitudinal axis parallel to each other,
the first upper electrical connector and the second upper electrical connector are corresponding male and female connectors and the first lower electrical connector and the second lower electrical connector are corresponding male and female connectors,
a non-conductive grommet is inserted in the first upper perforation,
a non-conductive grommet is inserted in the first lower perforation,
the non-conductive grommet comprises an opening for the passing of a electrical conductor, an upper part larger than the perforation and a lower part narrower than the perforation and a plurality of crenellations,
The outer central part of the outer sheet further comprises by-pass perforations.

A second subject of the present invention provides a sandwich panel, for building envelope, comprising an inner sheet, an outer sheet and an insulation material sandwiched between the inner sheet and the outer sheet, the insulation material having a first longitudinal side, a second longitudinal side, an upper transverse side and a lower transverse side, the sandwich panel having an upper half and a lower half,
the outer sheet comprising:
a first longitudinal outer flange including a first longitudinal rib projecting from the first longitudinal side of the insulation material,
an outer central part extending from the first longitudinal rib, including:
   a first upper perforation through which a first upper electrical conductor runs,
   a first lower perforation through which a first lower electrical conductor runs,
a first photovoltaic active area positioned on the outer central part and electrically connected to the first upper electrical conductor and to the first lower electrical conductor,
a second longitudinal outer flange extending from the outer central part and comprising a second longitudinal rib, the first longitudinal rib and the second longitudinal rib having shapes that allow the overlapping of the first longitudinal rib on the second longitudinal rib,
the backside of the outer sheet comprising:
a first upper cable running from the first upper electrical conductor, through at least an upper cavity and either a cut in the second longitudinal side of the insulation material or an upper hole in the inner sheet, up to a first upper electrical connector,
a first lower cable running from the first lower electrical conductor, through at least to a lower cavity and either a cut in the second longitudinal side of the insulation material or a lower hole in the inner sheet, up to a first lower electrical connector, the first lower electrical connector and the first upper electrical connector being corresponding male and female connectors,
the upper cavity being positioned within the insulation material in the upper half of the sandwich panel and adjacent to either the second longitudinal side of the insulation material or the inner sheet,
the lower cavity being positioned within the insulation material in the lower half of the sandwich panel and adjacent to either the second longitudinal side of the insulation material or the inner sheet.

The second subject of the invention may also have the optional features listed below, considered individually or in combination:
the outer sheet further comprises an upper transverse outer edge bordering an upper overlap area,
the outer sheet further comprises a lower transverse outer edge extending beyond the lower transverse side of the insulation material to form a lower overlap area, the upper overlap area and the lower overlap area having shapes that allow the overlapping of the lower overlap area on the upper overlap area.

A third subject of the present invention provides a process for manufacturing a sandwich panel according to the invention, comprising:
Providing an outer sheet comprising:
   an outer central part including:
      “a first upper perforation through which a first upper electrical conductor runs,” a first lower perforation through which a first lower electrical conductor runs,
      a first photovoltaic active area positioned on the outer central part and the first lower perforation and electrically connected to the first upper electrical conductor and to the first lower electrical conductor,
   the backside of the outer sheet comprising:
      a first upper cable connecting the first upper electrical conductor to a first upper electrical connector positioned in an upper cavity,
      a first lower cable connecting the first lower electrical conductor to a first lower electrical connector positioned in a lower cavity, the first lower electrical connector and the first upper electrical connector being corresponding male and female connectors,
   the upper cavity being positioned in the upper half of the outer sheet,
   the lower cavity being positioned in the lower half of the outer sheet outside of the lower overlap area,
Putting insulation in place,
Maintaining the inner sheet at a given distance from the outer sheet.

The third subject of the present invention may also have the optional features listed below, considered individually or in combination:
the upper cavity is attached to the backside of the outer sheet, in the upper half of the outer sheet,
the lower cavity is attached to the backside of the outer sheet, in the lower half of the outer sheet outside of the lower overlap area,
the inner sheet is provided and positioned at a given distance from the outer sheet,
the space between the inner sheet and the outer sheet is filled with an insulation material,
the inner sheet is provided cut to size and shaped, the outer sheet and the inner sheet are positioned in a mold at the given distance from each other and a reaction mix is injected in the mold between the inner sheet and the outer sheet so that the reaction mix reacts, expands to fill the gap between the inner sheet and the outer sheet and forms the insulation material,
the inner sheet is provided in the form of a coil and enters a double-belt conveyor of a manufacturing line as an inner strip, the outer sheet is part of a continuous feeding of the manufacturing line in outer sheets and a reaction mix is applied to the backside of the outer sheet or to the backside of the inner strip so that the reaction mix reacts, expands in the double-belt conveyor to fill the gap between the inner strip and the outer sheet and forms the insulation material,
the upper cavity and the lower cavity are positioned along the second longitudinal outer edge of the outer sheet,
the upper cavity and/or the lower cavity are positioned on at least one shim,
it further comprises, after filling the space with the insulation material, opening the upper cavity to give access to the first upper electrical connector and opening the lower cavity to give access to the first lower electrical connector,
it further comprises, before providing the outer sheet, preparing the outer sheet according to the following steps:
   the outer sheet is cut to length from a strip,
   the first upper perforation and the first lower perforation are done in the outer central part,
   the first photovoltaic active area is positioned on the outer central part,
   the backside of the outer sheet is equipped with the first upper junction box, the first upper cable, the first upper electrical connector, the first lower junction box, the first lower cable, the first lower electrical connector, the upper cavity and the lower cavity,
the outer sheet is shaped after lamination of the first photovoltaic active area,
the first photovoltaic active area is laminated on the outer central part.

A fourth subject of the present invention provides a process for the assembling of a building envelope on a building structure, comprising:
(i) providing a first and a second sandwich panel according to the invention,
(ii) fastening the first sandwich panel to the building structure,
(iii) positioning the second sandwich panel so that its lower overlap area covers the upper overlap area of the first sandwich panel and fastening the second sandwich panel to the building structure,
(iv) connecting the first upper electrical connector of the first sandwich panel to the first lower electrical connector of the second sandwich panel.

As it is apparent, the invention is based on the recourse to traditional methods for manufacturing sandwich panels, the semi-continuous method or the discontinuous method, where the laying of the insulation material is one of the last steps of the method, if not the last one. These traditional methods are substantially unchanged so that both standard sandwich panels and BIPV sandwich panels can be manufactured with the same existing line or press. Accordingly, the photovoltaic active area is positioned on the outer sheet alone, before the outer sheet is provided for the making of the sandwich panel. In particular, electrical conductors connected to the photovoltaic active area run through the outer sheet before lamination in such a way that the flatness of the lamination is not compromised. Also, except in the photovoltaic active area itself, there is no protruding part on the upper side of the outer sheet so that the laying of the insulation material in existing production facilities is not compromised. Also, the sandwich panel is prewired before the insulation is put in place in such a way that the cables needed to electrically connect adjacent panels are within the boundaries of the sandwich panel. In particular, the cables needed to electrically connect adjacent panels are reserved in cavities that get embedded in the insulation material, which can be opened afterwards to access, and possibly extract the cables and connect the panels. Also, as the sandwich panel is prewired before the insulation is put in place, the sandwich panel does not comprise any holes made in the outer sheet, the insulation material and the inner sheet. This improves the watertightness of the sandwich panel. Similarly, the sandwich panel does not comprise any holes in the inner sheet capable of receiving an electrical connector housing or capable of having an electrical connector housing inserted from the external surface of the inner sheet. Similarly, the cavities are not opened along the outer sheet, i. e are closed along the outer sheet.

Other characteristics and advantages of the invention will be described in greater detail in the following description.

### BRIEF DESCRIPTION OF THE DRAWINGS

The present invention will be better understood by reading the following description, which is provided purely for purposes of explanation and is in no way intended to be restrictive, with reference to:

FIG. 1, which is a perspective view of the sandwich panel according to the invention,

FIG. 2, which is a perspective view of the sandwich panel according to the invention,

FIG. 3, which is a perspective view of the sandwich panel according to the invention,

FIG. 5, which is a cross-section of the sandwich panel according to the invention,

FIG. 6, which is a perspective view of the sandwich panel according to the invention,

FIG. 7, which is a view of the upper side of the outer sheet of the sandwich panel according to the invention,

FIG. 8, which is a view of the grommet of the sandwich panel according to the invention,

FIG. 9, which is a cross-section of the sandwich panel according to a first embodiment of the invention,

FIG. 10, which is a view of the backside of the outer sheet of the sandwich panel according to the first embodiment of FIG. 9,

FIG. 11, which is a perspective view of the lower part of the sandwich panel according to the first embodiment,

FIG. 12, which is a perspective view of the upper part of the sandwich panel according to the first embodiment,

FIG. 13, which is a cross-section of the sandwich panel according to a second embodiment of the invention,

FIG. 14, which is a view of the backside of the outer sheet of the sandwich panel according to the second embodiment,

FIG. 15, which is a perspective view of the lower part of the sandwich panel according to the second embodiment,

FIG. 16, which is a perspective view of the upper part of the sandwich panel according to the second embodiment,

FIG. 17, which is a perspective view of the assembling of four sandwich panels according to the invention on a building structure,

FIG. 18, which is a perspective view of the assembling of two sandwich panels according to the first embodiment,

FIG. 19, which is a perspective view of two sandwich panels according to the first embodiment, assembled on the building structure,

FIG. 20, which is a perspective view of the assembling of two sandwich panels according to a first variant of the second embodiment,

FIG. 21, which is a perspective view of two sandwich panels according to a first variant of the second embodiment, assembled on the building structure,

FIG. 22, which is a perspective view of the assembling of two sandwich panels according to a second variant of the second embodiment, and

FIG. 23, which is a perspective view of two sandwich panels according to a second variant of the second embodiment, assembled on the building structure.

### DETAILED DESCRIPTION

It should be noted that the terms “inwards” and “outwards” as used in this application refer to the positions and orientations of the different constituent elements of the panel in relation to the position of the insulation material. Consequently, if an element extends inwards, it extends in the direction of the insulation material. Similarly, if the element extends outwards, it extends in the opposite direction of the insulation material.

It should also be noted that, to ease the description, the panels will be described in relation to their usual position on a building roof. Consequently, the terms “inner” and “outer” as used in this application refer to this usual position. Accordingly, the outer sheet is facing the outside and the inner sheet is facing the inside of the building. Accordingly, the inner flange refers to the flange of the inner sheet and the outer flange refers to the flange of the outer sheet. Similarly, spatially relative terms such as “above”, “below” . . . as used in this application refer to the positions and orientations of the different constituent elements of the sandwich panel when the latter is positioned on a roof. Accordingly, “below” does not mean “underneath”.

Throughout the text, a photovoltaic active area is understood to mean a stack of a plurality of layers which comprises a layer:
capable of converting solar energy into electricity, and
protected from the outside by insulating layers.

Such stacks usually comprise a foil of insulating material called backsheet, a first layer of encapsulation material, solar cells connected via ribbons and busbars, a second layer of encapsulation material and a transparent foil of insulation material called frontsheet. The solar cells are usually themselves composed of several layers among which a substrate, a back-electrode, a p-n junction (which is capable of converting solar energy into electricity) and a front electrode. The solar cells can notably be wafer-based crystalline silicon cells or thin-film cells. The solar cells can be grouped into modules. The photovoltaic active area can comprise bypass diodes, generally placed every 18-24 cells, which prevent the destructive effects of hot-spot heating when a cell or module becomes shaded or faulty. Each photovoltaic active area has a first polarity and a second polarity, for connection to other photovoltaic active areas or to the grid. More preferably, each photovoltaic active area does not have more than a single pair of a first polarity and a second polarity. When two or more photovoltaic active areas are positioned next to each other, they can have their own backsheet and frontsheet or they can share one single backsheet and/or one single frontsheet.

Throughout the text, a sheet is understood to mean an element that has a flat shape, i.e., its thickness is low compared to its other dimensions. Generally speaking, its thickness is 500 to 4000 times lower than its width. The sheet may be made of a single material or a composite assembly. In the latter case, the sheet is a stack of a plurality of layers of the same material or different materials. The material in question may be, among others, a metallic material or a polymer. Steel, aluminum, copper and zinc may be cited as non-restricting examples of metallic materials. The sheet is preferably a metallic sheet. It is preferably made of previously galvanized and pre-coated steel to protect it against corrosion. The inner sheet and the outer sheet are examples of sheets.

In the context of the invention, the sheet will preferably have been previously formed with the aid of any known forming method, including, by way of non-restricting examples, bending, forming, stamping and molding. In particular, the U-shaped bend described later on is an element of the panel whose manufacturing process is not limited to bending.

This forming leads among other things to the formation of ribs, stiffeners or grooves on the surface of the sheet. Throughout the text, a rib is understood to mean a protrusion formed on the surface of the sheet. The rib may have a trapezoidal shape or a rectangular, corrugated, sinusoidal or even omega shape, for example. It includes a top central part and two lateral wings. A stiffener is a rib of limited height, generally 10 to 30 times lower than a rib. Ribs or stiffeners are generally placed in parallel to the longitudinal edges of the sheet notably to render the sheet more rigid and are then defined as longitudinal ribs or longitudinal stiffeners. Throughout the text, a groove is understood to mean a recess formed on the surface of the panel. The groove can have shapes similar to the ones offered for ribs.

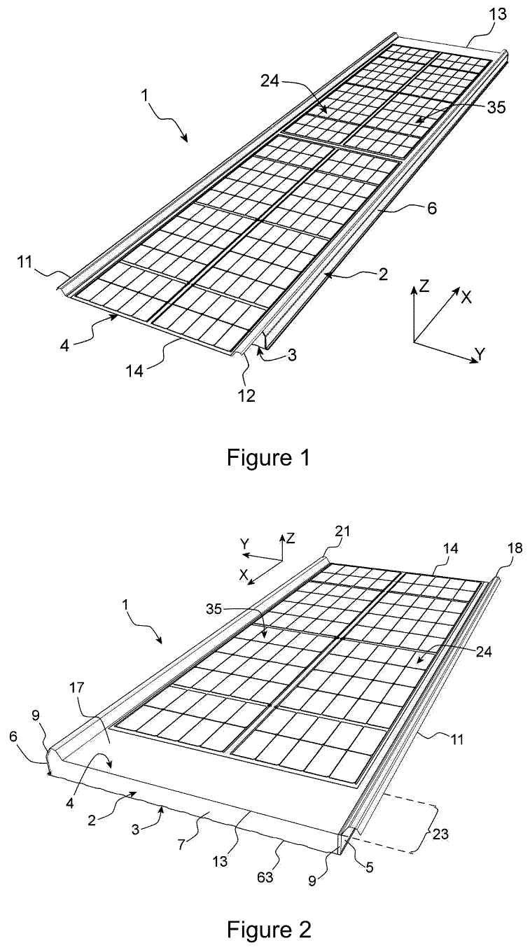

With reference to FIGS. 1 to 4, the sandwich panel 1 according to the invention first comprises an insulation material 2 sandwiched between an inner sheet 3 and an outer sheet 4. The insulation material is delimited by a first longitudinal side 5, a second longitudinal side 6, an upper transverse side 7 and a lower transverse side 8. The inner sheet substantially lies down flat in a plane P.

The insulation material 2 can be any material providing some insulation to the sandwich panel 1. It can be, by way of non-restricting examples, polyurethane foam, polyisocyanurate foam, phenolic foam, mineral wool, wood wool and their mixtures. It is preferably a foamed insulation material.

Some of the sides of the insulation material, in particular the longitudinal sides, can be covered with an edge band 9 running along the given side(s). The edge band notably prevents the insulation foam from expanding beyond the sandwich panel during manufacturing and prevents the equipment from being soiled by the foam. The edge band can be made of, by way of non-restricting examples, foamed plastic, plastic film, kraft paper, cardboard.

Some of the sides, in particular the transverse sides, can be covered with a cap 10 substantially closing the gap between the inner sheet 3 and an outer sheet 4. Such caps are usually used in the discontinuous manufacturing methods to prevent the insulation foam from expanding beyond the sandwich panel during manufacturing. They can be made of, by way of non-restricting examples, foamed plastic, plastic film, kraft paper, cardboard.

With reference to FIGS. 2, 4 and 5, the outer sheet 2 is a sheet of rectangular shape comprising a first longitudinal outer edge 11, a second longitudinal outer edge 12, an upper transverse outer edge 13 and a lower transverse outer edge 14. A first longitudinal outer flange 15 runs along the first longitudinal outer edge 11 and a second longitudinal outer flange 16 runs along the second longitudinal outer edge 12. The first longitudinal outer flange 15 and the second longitudinal outer flange 16 are connected by an outer central part 17. The latter substantially lies down flat in a plane parallel to plane P.

The sandwich panel is designed so that the first longitudinal outer flange 15 of a first sandwich panel can overlap the second longitudinal outer flange 16 of a second sandwich panel laterally adjacent and so that the second longitudinal outer flange of the first sandwich panel can be overlapped by the first longitudinal outer flange of a third sandwich panel laterally adjacent.

Consequently, as illustrated in FIGS. 1 to 4, the first longitudinal outer flange 15 of the outer sheet comprises a first longitudinal rib 18, as defined above, projecting from the first longitudinal side 5 of the insulation material. By “projecting”, it is meant that the first longitudinal outer flange extends beyond the first longitudinal side of the insulation material, in particular beyond the plane of the first longitudinal side. In the example illustrated, the first longitudinal rib 18 has a trapezoidal shape with a top central part 19 and two lateral wings 20. As the first longitudinal rib 18 projects from the insulation material, its underside is thus not covered with the insulation material. The first longitudinal rib 18 can thus overlap the second longitudinal outer flange 16 of a sandwich panel laterally adjacent without discontinuity in the insulation material.

Accordingly, the second longitudinal outer flange 16 of the outer sheet comprises a second longitudinal rib 21, the first longitudinal rib 18 and the second longitudinal rib 21 having shapes that allow the overlapping of the first longitudinal rib on the second longitudinal rib. In the example illustrated, the second longitudinal rib 21 has a trapezoidal shape, with a top central part 19 and two lateral wings 20, with substantially the same shape as the first longitudinal rib 18. It provides an efficient watertightness. The underside of the second longitudinal rib is preferably fully covered with the insulation material. It further improves the thermal insulation of the assembly.

Similarly, the sandwich panel is preferably designed so that the lower part of a first sandwich panel can partially overlap the upper part of a second sandwich panel positioned lower along the roof slope and so that the upper part of the first sandwich panel can be partially overlapped by the lower part of a third sandwich panel positioned higher along the roof slope.

Consequently, the lower transverse outer edge 14 of the outer sheet preferably extends beyond the lower transverse side 8 of the insulation material. The corresponding projection, i.e. the portion of the outer sheet extending from its lower transverse outer edge 14 to the lower transverse side 8 of the insulation material, is defined as the lower overlap area 22. As its underside is not covered with the insulation material, the lower overlap area of one sandwich panel can cover the upper part of a lower adjacent sandwich panel. The upper part of the sandwich panel that can be covered by the lower overlap area is defined as the upper overlap area 23. It is bordered by the upper transverse outer edge 13 and its height (taken parallel to the longitudinal edge of the outer sheet) is de facto substantially identical to the distance between the lower transverse outer edge 14 of the outer sheet and the lower transverse side 8 of the insulation material (i.e. the height of the lower overlap area) since sandwich panels are assembled without discontinuities in the insulation material. The height of the upper overlap area and lower overlap area is generally comprised between 150 and 500 mm, depending notably on the roof pitch.

The lower overlap area 22 and the upper overlap area 23 have shapes that allow the overlapping of the lower overlap area on the upper overlap area. This means that, apart from the portions of the first longitudinal rib 18 and second longitudinal rib 21 that are present in the upper and lower overlap areas, the lower overlap area 22 and the upper overlap area 23 do not comprise shaped areas that prevent the overlapping. Such areas might be, for example, a groove in the lower overlap area that does not match a groove in the upper overlap area. Preferably, apart from the portions of the first longitudinal rib 18 and second longitudinal rib 21 that are present in the upper and lower overlap areas, the lower overlap area 22 and the upper overlap area 23 are preferably flat.

The sandwich panel is divided into an upper half and a lower half. The upper half starts from the upper transverse side 7 of the insulation material (which corresponds to the upper transverse outer edge 13 of the outer sheet) and extends to half the length of the outer sheet (the length being taken parallel to the longitudinal edge of the outer sheet). The upper half of the sandwich panel thus corresponds to the upper half of the outer sheet. The lower half starts from the lower transverse outer edge 14 of the outer sheet and extends to half the length of the outer sheet. The lower half of the sandwich panel thus corresponds to the lower half of the outer sheet.

With reference to FIGS. 1 and 2, the sandwich panel 1 is a building integrated photovoltaic (BIPV) sandwich panel. Accordingly, it comprises a first photovoltaic active area 24, as defined above, positioned on the outer central part 17 and the components for the electrical connections of the first photovoltaic active area to other sandwich panels or to the grid are integrated in the thickness of the sandwich panel.

In particular, the first photovoltaic active area 24 is directly built on the outer central part of the outer sheet before the sandwich panel is manufactured. In particular, it is laminated on the outer central part of the outer sheet. It strongly improves the watertightness of the sandwich panel.

The first photovoltaic active area 24 is preferably dimensioned that, on one hand, no part of it is covered by an adjacent sandwich panel when the panels are assembled and, on the other hand, the active surface is maximized. Accordingly, the upper transverse edge of the first photovoltaic active area is positioned below the upper overlap area 23, preferably as close as possible to the upper overlap area and the lower transverse edge of the first photovoltaic active area is positioned in the lower overlap area 22, preferably as close as possible to the lower transverse outer edge 14 of the outer sheet. Similarly, in the variant of the invention where there is only one photovoltaic active area, the first longitudinal edge of the first photovoltaic active area is as close as possible to the first longitudinal rib and the second longitudinal edge of the first photovoltaic active area is as close as possible to the second longitudinal rib. A first polarity of the first photovoltaic active area is preferably positioned in the upper half of the first photovoltaic active area, more preferably adjacent to the upper transverse edge, below the upper overlap area. A second polarity of the first photovoltaic active area is preferably positioned in the lower half of the first photovoltaic active area, more preferably adjacent to the lower overlap area 22 of the sandwich panel.

The first photovoltaic active area 24 is electrically connected to a first upper electrical conductor 25 and to a first lower electrical conductor 26. In particular, a first polarity of the first photovoltaic active area is connected to the first upper electrical conductor and a second polarity of the first photovoltaic active area is connected to the first lower electrical conductor. As the first photovoltaic active area 24 is on the upper side of the outer sheet and the electrical connections are in the thickness of the sandwich panel, the first upper and first lower electrical conductors run through the outer sheet. In the variant illustrated in FIG. 6, the first upper electrical conductor 25 and the first lower electrical conductor 26 are conductive ribbons, also known as conductive busbars. They are part of the first photovoltaic active area. They are preferably directly connected to PV cells of the first photovoltaic active area. They are both running on the surface of the outer sheet and then through the outer sheet. In another variant the first upper electrical conductor 25 and the first lower electrical conductor 26 are intermediate electrical conductors connected to a conductive ribbon of the first photovoltaic active area. The first upper electrical conductor 25 and the first lower electrical conductor 26 can notably be embedded in a non-conductive grommet 29 described below. In that case, the conductive ribbons of the first photovoltaic active area can run on the surface of the outer sheet and can be connected to the first upper electrical conductor 25 and the first lower electrical conductor 26 that run through the outer sheet.

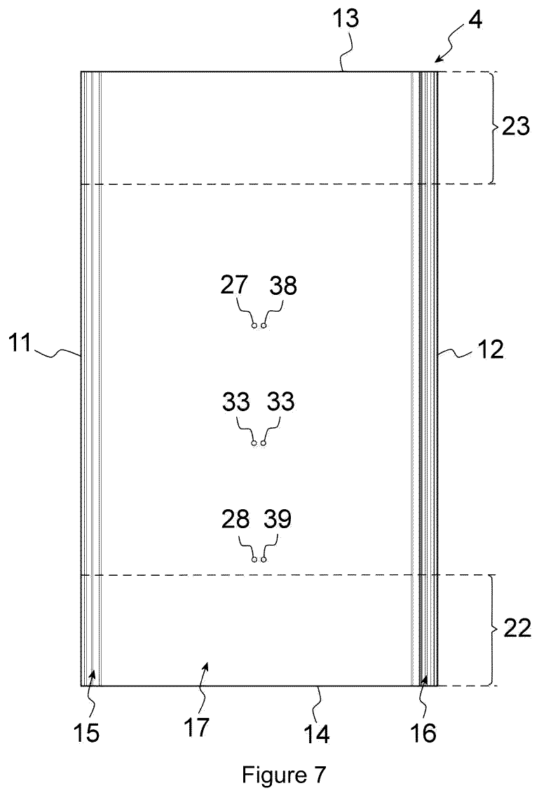

Consequently, and with reference to FIG. 7, the outer central part 17 comprises a first upper perforation 27 through which the first upper electrical conductor runs and a first lower perforation 28 through which the first lower electrical conductor runs. The positions of the first upper perforation and first lower perforation can depend notably on the positions of the first and second polarities of the photovoltaic active area and on the positions of the electrical connections in the thickness of the sandwich panel. Generally speaking, the first upper perforation is preferably positioned in the upper half of the sandwich panel and the first lower perforation is preferably positioned in the lower half of the sandwich panel outside of the lower overlap area 22. As the first photovoltaic active area 24 preferably has its first polarity adjacent to its upper transverse end below (i.e. adjacent to) the upper overlap area 23 and its second polarity adjacent to the lower overlap area, the first upper perforation 27 is preferably positioned below (i.e. adjacent to) the upper overlap area and the first lower perforation 28 is preferably positioned adjacent to the lower overlap area. Preferably, the first upper perforation and first lower perforation are substantially aligned in the longitudinal axis X.

Preferably, the width of the perforations (i.e. the longest length measured in the X-Y plane) is of the order of magnitude of the diameter of an electrical connector, as described below. In particular, the width is inferior to 3 cm, more preferably inferior to 2 cm. In other words, the perforations are not capable of receiving an electrical connector housing. Such a width further minimizes the negative impact a hole can have on the lamination of the photovoltaic active area on the outer sheet alone and further improves the watertightness of the sandwich panel.

For water proofing reasons, the first upper and first lower perforations are preferably covered by at least one layer of the first photovoltaic active area. More preferably, the first upper and first lower perforations are covered by the frontsheet. Even more preferably, they are covered by the frontsheet, a layer of encapsulation material and possibly at least partially the backsheet. Also, the first upper and first lower perforations can be substantially below the layer capable of converting solar energy into electricity. By substantially below it is meant here that they can be below this layer even if there are no PV cells strictly above the perforations. The first upper and first lower perforations can also be substantially covered by the first photovoltaic active area. By substantially covered, it is meant here that they are overall below the photovoltaic active area even if the perforations are not strictly covered by all the layers of the photovoltaic active area.

Preferably, the inward end of the first upper electrical conductor is adjacent to the first upper perforation. This inward end can also be substantially plumb with the first upper perforation. Preferably, the inward end of the first lower electrical conductor is adjacent to the first lower perforation. This inward end can also be substantially plumb with the first lower perforation.

Having the first upper electrical conductor going through the first upper perforation and the first lower electrical conductor going through the first lower perforation is advantageous. As there are no junction boxes or other protruding parts on the upper side of the outer sheet, the step of forming the insulation material in existing production facilities is not compromised. Also, in the case of electrical conductors in the form of conductive ribbons or in the case of electrical conductors integrated in a non-conductive grommet, as they are thin, their ends lying against the backside of the outer sheet during the lamination of the photovoltaic active area have no impact on the flatness of the outer sheet. Accordingly, the lamination of the photovoltaic active area can be efficiently performed on the outer sheet alone, without modifying existing lamination equipment to accommodate parts protruding from the surface of the backside of the outer sheet. Moreover, in the case of electrical conductors in the form of conductive ribbons, the connection of the conductive ribbon to the rest of the electrical circuit is not done between the outer sheet and the photovoltaic active area. Such connection tends to be thick compared to the thickness of the photovoltaic active area and to jeopardize the lamination of the latter.

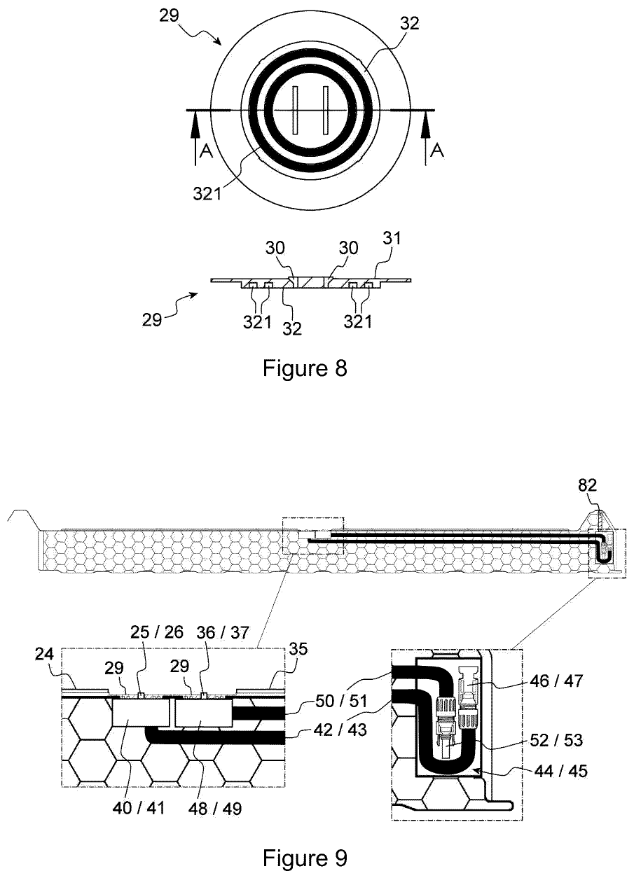

With reference to FIGS. 8, 9 and 13, for electrical safety reasons, and in the case where the outer sheet is made of a conductive material, the first upper electrical conductor 25, respectively the first lower electrical conductor 26, is preferably electrically insulated from the edge of the first upper perforation 27, respectively first lower perforation 28, by a non-conductive grommet 29 inserted in the first upper perforation, respectively first lower perforation. Firstly, the non-conductive grommet can comprise an opening 30 for the passing of an electrical conductor. The size of the opening is adapted to the size of the electrical conductor. The non-conductive grommet can further comprise an upper part 31 larger than the perforation. The non-conductive grommet can thus rest on the outer sheet. The upper part can be thin enough to further avoid lamination issues of the photovoltaic active area. The non-conductive grommet can further comprise a lower part 32 narrower than the perforation and comprising a plurality of crenellations 321. The lower part being narrower than the perforation, the non-conductive grommet can easily be positioned in the perforation. The crenellations extend the surface distance between the opening 30 and the periphery of the grommet and thus extend the creepage distance between the electrical conductor and the outer sheet. They are preferably concentric. Thanks to the crenellations engraved in the lower part, the electrical conductor emerging from the non-conductive grommet on the backside of the outer sheet is kept at a safe surface distance from the conductive metal. The non-conductive grommet can comprise another opening 30, adjacent to the first one for the passing of a second electrical conductor.

Preferably, the thickness of the grommet is of the thickness of the outer sheet (0.5-1 mm). In particular, the grommet is less than 2 mm thick, more preferably less than 1 mm thick. Preferably, the grommet does not protrude substantially below the surface of the backside of the outer sheet, in particular of the backside of the outer central part. In particular, the grommet does not protrude over more than 1 mm below the surface of the backside of the outer sheet. In other words, the surface of the bottom part of the grommet is substantially flush with the surface of the backside of the outer sheet. Thanks to this design, the lamination of the photovoltaic active area can be efficiently performed on the outer sheet alone, without modifying existing lamination equipment to accommodate parts protruding from the surface of the backside of the outer sheet. Furthermore, the grommet has no impact on the flatness of the outer sheet.

Preferably, the width of the grommet (i.e. the longest length measured in the X-Y plane) is of the diameter of an electrical connector, as described below. In particular, the width is inferior to 3 cm, more preferably inferior to 2 cm. Such a width further improves the quality of the lamination of the photovoltaic active area on the outer sheet.

Preferably, the first upper perforation 27 is not traversed by anything other than the first upper electrical conductor, and the non-conductive grommet if any and a second electrical conductor if any. Preferably, the first lower perforation 28 is not traversed by anything other than the first lower electrical conductor, and the non-conductive grommet if any and a second electrical conductor if any.

With reference to FIGS. 7, 10 and 14, the outer central part 17 of the outer sheet 4 can further comprise by-pass perforations 33. The latter allow the addition of by-pass diodes 34 of the first photovoltaic active area at the backside of the outer sheet. As the by-pass diodes are thicker than the layers of the first photovoltaic active area, inserting them directly in the first photovoltaic active area tends to jeopardize the integrity of the latter. Thanks to the by-pass perforations, conductive ribbons from the first photovoltaic active area can go through the outer sheet, be connected to a by-pass diode and go through the outer sheet again.

The by-pass perforations are preferably regularly positioned along the longitudinal direction of the first photovoltaic active area. They are preferably positioned as far as possible from the edges of the frontsheet of the photovoltaic active area, in the transverse direction, to prevent water leaks.

Preferably, the width of the by-pass perforations (i.e. the longest length measured in the X-Y plane) is of the order of magnitude of the diameter of an electrical connector, as described below. In particular, the width is inferior to 3 cm, more preferably inferior to 2 cm. In other words, the by-pass perforations are not capable of receiving an electrical connector housing. Such a width further minimizes the negative impact a hole can have on the lamination of the photovoltaic active area on the outer sheet alone and further improves the watertightness of the sandwich panel.

In the case where the outer sheet is made of a conductive material, non-conductive grommets 29 are preferably inserted in the by-pass perforations to insulate the conductive ribbons from the by-pass perforations. These grommets have the same features as the ones described above except in that they comprise two openings: one for the conductive ribbon coming from the first photovoltaic active area and one for the conductive ribbon going back to the first photovoltaic active area.

According to one variant of the invention illustrated in FIGS. 1, 2, 6 and 7, the sandwich panel 1 comprises a second photovoltaic active area 35 positioned on the outer central part 17. The second photovoltaic active area 35 is positioned beside the first photovoltaic active area 24. Preferably, the first photovoltaic active area and the second photovoltaic active area extend in the longitudinal axis parallel to each other. The outer sheet can comprise a third longitudinal rib positioned between the first photovoltaic active area and the second photovoltaic active area.

In particular, a first polarity of the second photovoltaic active area is positioned in the upper half of the second photovoltaic active area, more preferably adjacent to the upper transverse end of the second photovoltaic active area, below the upper overlap area 23. This first polarity is preferably of opposite polarity to the first polarity of the first photovoltaic active area. In particular, a second polarity of the second photovoltaic active area is positioned in the lower half of the second photovoltaic active area, more preferably adjacent to the lower overlap area 22 of the sandwich panel. This second polarity is preferably of opposite polarity to the second polarity of the first photovoltaic active area. The second photovoltaic active area 35 is electrically connected to a second upper electrical conductor 36 and to a second lower electrical conductor 37. Consequently, the outer central part 17 comprises a second upper perforation 38 through which the second upper electrical conductor runs and a second lower perforation 39 through which the second lower electrical conductor runs. The features and variants detailed in relation to the first photovoltaic active area and the corresponding features of the outer sheet apply here. Alternatively, the second upper electrical conductor run through the first upper perforation 27 and the second lower electrical conductor run through the first lower perforation 28.

As mentioned above in relation to the first photovoltaic active area 24, the first upper electrical conductor 25 and the first lower electrical conductor 26 go through the outer sheet 4. On the backside of the outer sheet, the first upper electrical conductor 25 is connected to a first upper cable 42 and the first lower electrical conductor 26 is connected to a first lower cable 43. The way the electrical connections are done is not limited. It can be done by welding. The upper cable and lower cable are preferably insulated. The upper cable and lower cable can comprise a sleeve, in at least one portion.

For electrical safety reasons, and to facilitate the integration of the photovoltaic function in the sandwich panel, the first upper electrical conductor and the first lower electrical conductor are preferably insulated from the insulation material 2. In the variant illustrated in FIGS. 9, 10, 13 and 14, the first upper electrical conductor is preferably connected to the first upper cable in a first upper junction box 40 and the first lower electrical conductor is preferably connected to the first lower cable in a first lower junction box 41. A junction box is an electrical enclosure in which electrical wiring connections are safely made. The first upper junction box 40 and the first lower junction box 41 are part of the backside of the outer sheet 4. Both junction boxes preferably comprise a casing. The casing preferably comprises a conductor opening or ribbon opening and a cable opening. In a variant, the junction box 40, 41 comprises a non-conductive grommet 29, as described above.

The first upper junction box 40, respectively the first lower junction box 41, is preferably positioned in contact with the backside of the outer sheet, substantially plumb with the first upper perforation 27, respectively first lower perforation 28, so that there is no gap between the outer sheet and the junction boxes. The junction boxes can be attached to the backside of the outer sheet, for example by gluing.

Thanks to this configuration, the connection of the electrical conductors on the backside of the outer sheet does not jeopardize the integrity and quality of the first photovoltaic active area. Moreover, the junction boxes can further improve the watertightness at the level of the perforations.

The first upper cable 42 and first lower cable 43 run through the insulation material until they enter a cavity. The first upper cable 42 enters an upper cavity 44 and the first lower cable 43 enters a lower cavity 45.

The portion of the cable running through the insulation can comprise a sleeve. By “run through the insulation material”, it is meant that the cable, possibly comprising a sleeve, is closely surrounded by the insulation material. It is the result of the laying of the insulation after the cable has been positioned.

Between its cavity and its respective electrical conductor, or respective junction box if applicable, each cable, possibly comprising a sleeve, is preferably substantially embedded in the insulation material. In other words, this portion of the cable is irremovable. The substantial embedment of this portion of cables in the insulation material can be the result of the foaming of the insulation material around the cable or the result of the attachment of the cable to the insulation material, for example by gluing. This substantial embedment facilitates the process for manufacturing the sandwich panel since no specific step has to be performed to isolate this portion of the cables from the insulation material before the latter is put in place.

In each cavity, each cable is connected to an electrical connector. The first upper cable is connected to a first upper electrical connector 46 and the first lower cable is connected to a first lower electrical connector 47. The first upper electrical connector and first lower electrical connector are corresponding male and female connectors. The first upper electrical connector can be the male connector and the first lower electrical connector the female connector or vice versa.

These first electrical connectors allow the electrical connection of the first photovoltaic active area to other photovoltaic active areas and/or to the grid. In particular, one polarity of the first photovoltaic active area can be connected to one polarity of a first photovoltaic active area of a second sandwich panel positioned adjacently higher along the roof slope by connecting, directly or indirectly, the first upper electrical connector 46 of the sandwich panel to the first lower electrical connector 47 of the second sandwich panel. Similarly, the other polarity of the first photovoltaic active area can be connected to one polarity of a first photovoltaic active area of a third sandwich panel positioned adjacently lower along the roof slope by connecting, directly or indirectly, the first lower electrical connector 47 of the sandwich panel to the first upper electrical connector 46 of the third sandwich panel. Alternatively, the first upper electrical connector 46 or the first lower electrical connector 47 of the sandwich panel can be connected to the grid. The role and features of the cavities will be detailed later on.

With reference to FIGS. 9, 10, 13 and 14, according to the variant of the invention in which the sandwich panel 1 comprises a second photovoltaic active area 35 positioned on the outer central part 17, the backside of the outer sheet 4 comprises a second upper cable 50 connected to the second upper electrical conductor 36 and a second lower cable 51 connected to the second lower electrical conductor 37. In the variant illustrated, the second upper cable 50 is connected to the second upper electrical conductor 36 in a second upper junction box 48 and the second lower cable 51 is connected to the second lower electrical conductor 37 in a second lower junction box 49. The features and variants detailed in relation to the first junction boxes apply here. Alternatively, the second upper cable 50 is connected to the second upper electrical conductor 36 in the first upper junction box 40 and the second lower cable 51 is connected to the second lower electrical conductor 37 in a first lower junction box 40.

Each second cable runs through the insulation material until it enters a cavity. The second upper cable enters the upper cavity 44 in which the first upper cable 42 enters too. The second lower cable enters the lower cavity 45 in which the first lower cable 43 enters too. Between its cavity and its respective electrical conductor, or respective junction box if applicable, each second cable is preferably substantially embedded in the insulation material. The cable is preferably insulated for that purpose. In each cavity, each second cable is connected to an electrical connector. The second upper cable is connected to a second upper electrical connector 52 and the second lower cable is connected to a second lower electrical connector 53. The second upper electrical connector and second lower electrical connector are corresponding male and female connectors. The second upper electrical connector can be the male connector and the second lower electrical connector the female connector or vice versa.

These second electrical connectors allow the electrical connection of the second photovoltaic active area to other photovoltaic active areas and/or to the grid. In particular, one polarity of the second photovoltaic active area can be connected to one polarity of a second photovoltaic active area of a second sandwich panel positioned adjacently higher along the roof slope by connecting, directly or indirectly, the second upper electrical connector 52 of the sandwich panel to the second lower electrical connector 53 of the second sandwich panel. Similarly, the other polarity of the second photovoltaic active area can be connected to one polarity of a second photovoltaic active area of a third sandwich panel positioned adjacently lower along the roof slope by connecting, directly or indirectly, the second lower electrical connector 53 of the sandwich panel to the second upper electrical connector 52 of the third sandwich panel. Alternatively, the second upper electrical connector 52 or the second lower electrical connector 53 of the sandwich panel can be connected to the grid.

The first upper electrical connector 46 and the second upper electrical connector 52, which are both positioned in the upper cavity 44, are preferably corresponding male and female connectors. Similarly, the first lower electrical connector 47 and the second lower electrical connector 53, which are both positioned in the lower cavity 45, are preferably corresponding male and female connectors. Thanks to this configuration, each cavity contains a male connector and a female connector. Consequently:
with the connectors in the upper cavity, the first photovoltaic active area 24 can be connected to the first photovoltaic active area of a second sandwich panel positioned adjacently higher along the roof slope, while the second photovoltaic active area 35 can be connected to the second photovoltaic active area of the second sandwich panel, without mismatch,
with the connectors in the lower cavity, the first photovoltaic active area 24 can be connected to the first photovoltaic active area of a third sandwich panel positioned adjacently lower along the roof slope, while the second photovoltaic active area 35 can be connected to the second photovoltaic active area of the third sandwich panel, without mismatch,
with the connectors in the upper cavity, the first photovoltaic active area 24 can be connected to the second photovoltaic active area 35, so that the electrical circuit is looped for example at the roof ridge,
with the connectors in the lower cavity, the first photovoltaic active area 24 can be connected to the second photovoltaic active area 35, so that the electrical circuit is looped for example at the roof gutter.

As mentioned above in relation to the electrical connectors, the sandwich panel further comprises an upper cavity 44 and a lower cavity 45. By “cavity”, it is meant a hollow space within the insulation material. This hollow space is dimensioned so that it can accommodate a first electrical connector and a portion of a first cable, and possibly a second electrical connector and a portion of a second cable.

The cavity can be a substantially rectangle parallelepiped. It can extend in the longitudinal direction or in the transverse direction. The cavity preferably comprises a casing embedded in the insulation material. By “embedded”, it is meant that the casing is fixed firmly into the insulation material and intricately linked to it. This embedment can be the result of the foaming of the insulation material around the casing or the result of the attachment of the casing to the insulation material, for example by gluing. The cavity can be fully delimited by the casing. Alternatively, it can be delimited in part by the casing and in part by other components of the sandwich panel, such as, for example, the edge band 9, the cap 10, the outer sheet 4, the inner sheet 3.

The material used for the casing is not limited. It can be, for example, plastic, a foamed material, mineral wool, wood wool. In the case of the insulation material formed by expansion of a reaction mix, the material is preferably selected so that the cavity is not significantly shrunk during the expansion of the reaction mix.

Both cavities are positioned within the insulation material. By that expression, it is meant that no single part of the cavity, and in particular no single part of its casing is outside the limits of the insulation material. In particular, no single part of the cavity protrudes from either the first longitudinal side 5 or the second longitudinal side 6, or the upper transverse side 7 or the lower transverse side 8 of the insulation material. With this configuration, the sandwich panel can be produced as a standard sandwich panel in existing production facilities.

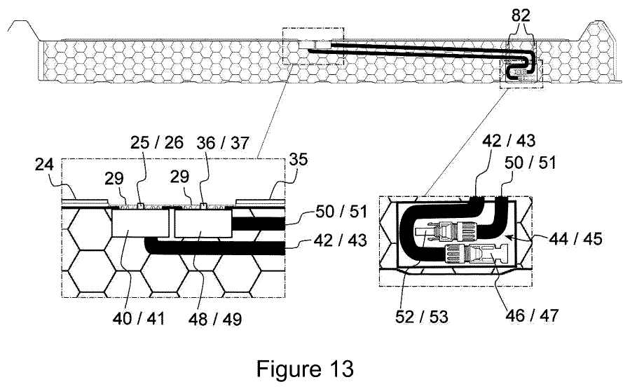

With reference to FIGS. 9 and 13, the upper cavity 44 comprises the first upper electrical connector 46 and a portion of the first upper cable 42. Preferably, this portion of the first upper cable is long enough so that the first upper electrical connector can be extracted from the upper cavity. More preferably, this portion of the first upper cable is folded in the upper cavity. This folding eases the extraction. In the variant of the invention in which the sandwich panel 1 comprises a second photovoltaic active area 35, the upper cavity 44 further comprises the second upper electrical connector 52 and a portion of the second upper cable 50. This portion is preferably folded in the upper cavity. Respectively, the lower cavity 45 comprises the first lower electrical connector 47 and a portion of the first lower cable 43. Preferably, this portion of the lower upper cable is long enough so that the first lower electrical connector can be extracted from the lower cavity. More preferably, this portion of the first lower cable is folded in the lower cavity. In the variant of the invention in which the sandwich panel 1 comprises a second photovoltaic active area 35, the lower cavity 45 further comprises the second lower electrical connector 53 and a portion of the second lower cable 51. This portion is preferably folded in the lower cavity.

In order to ease the insertion of the upper or lower cables in the cavity, the casing of the cavity preferably comprises an inlet for cable insertion. The casing can also comprise an outlet for accessing the electrical connector(s). Alternatively, the electrical connectors can be accessed by cutting the casing of the cavity.

The main purpose of both cavities is firstly to prevent the electrical connectors of the photovoltaic active area(s) from being trapped in the insulation material during the manufacturing process of the sandwich panel and, secondly, to permit an easy access to the electrical connectors during the assembling of sandwich panels and, in particular, during the electrical connection of the photovoltaic active areas of adjacent panels. Accordingly, first of all, the upper cavity 44 is positioned in the upper half of the sandwich panel and the lower cavity 45 is positioned in the lower half of the sandwich panel (consequently outside of the lower overlap area 22). This way, there is no risk of cable crossing when the photovoltaic active areas of adjacent panels are electrically connected. Secondly, the cavities are positioned adjacent to one side of the insulation material or adjacent to the inner sheet so that they can:
give access to the electrical connectors, possibly after being opened, and
allow the connectors to be extracted from the cavity if the portion of the cable present in the cavity is long enough to do so.

According to a first embodiment of the invention illustrated in FIGS. 9, 10 and 12, the upper cavity 44 is positioned adjacent to the second longitudinal side 6 of the insulation material. This way, when a sandwich panel is positioned on a roof by overlapping the second longitudinal rib 21 of an adjacent panel with the first longitudinal rib 18 of the sandwich panel, the second longitudinal side of the insulation material remains accessible to the operator. The latter can thus easily open the cavity, if it has not been done at a previous step, and access the connector(s) to connect them to the electrical connector(s) of sandwich panels adjacent along the roof slope or to the grid. In particular, the casing of the upper cavity is positioned adjacent to the second longitudinal side. More particularly, a wall of the casing is positioned adjacent to the second longitudinal side. It can be a plain wall or a wall comprising an outlet for accessing the electrical connector(s). This wall can be in the plane of the second longitudinal side. In that case, this wall and, if applicable, the outlet for accessing the electrical connector(s) are not in contact with the insulation material. The upper cavity, in particular its casing, can be adjacent to the edge band 9. Preferably, the upper cavity is positioned, along the longitudinal axis X of the sandwich panel, between the first upper perforation and the upper transverse side 7 of the insulation material. This position limits the length of cables needed to connect the photovoltaic active areas. More preferably, the upper cavity is adjacent to the upper transverse side 7 of the insulation material. It further limits the length of cables running between sandwich panels and facilitates the connections between panels.

In this embodiment, when the electrical connectors with a portion of cable are extracted from the upper cavity or when additional cables are connected to the electrical connectors, the cables should not prevent the sandwich panels from being assembled contiguously. Consequently, there are different ways to have the upper cavity open and/or to have the electrical connectors accessed from the upper cavity and to have the cables run.

In one variant of the first embodiment illustrated in FIG. 12, the upper cavity adjacent to the second longitudinal side 6 is open along the second longitudinal side 6 of the insulation material, possibly through a cut in the insulation material and/or through a cut in the edge band 9 and/or through a cut in the casing of the upper cavity. Accordingly, the second longitudinal side of the insulation material comprises an upper cutout 54 extending from the upper cavity to the upper transverse side, so that the cable(s) can run in the upper cutout.

In another variant of the first embodiment where the upper cavity is adjacent to the second longitudinal side 6 and to the upper transverse side 7 of the insulation material, the upper cavity is open along this upper transverse side, possibly through a cut in the insulation material and/or through a cut in the cap 10 and/or through a cut in the casing of the upper cavity. In that case, the electrical connector(s) can be extracted from the upper cavity, connected to the electrical connector(s) of a sandwich panel being positioned adjacently higher along the roof slope and retracted in the upper cavity when the two sandwich panels are positioned contiguously. Alternatively, if the upper cavity is open along both the upper transverse side and the second longitudinal side, the two panels can be positioned contiguously and then the electrical connector(s) can be connected while remaining in the upper cavity.

In another variant of the first embodiment, the upper cavity adjacent to the second longitudinal side 6 is open along the inner sheet 3, for example with an upper hole in the inner sheet, possibly through a cut in the insulation material and/or through a cut in the casing of the upper cavity. In this variant, the electrical connector(s) can be accessed from the inside of the building and/or from the side as they are at hand reach from the second longitudinal side. They do not prevent the sandwich panels from being assembled contiguously and they can be connected from the inside of the building and/or from the side. This variant is made easier if the upper cavity is adjacent to the inner sheet in addition to being adjacent to the second longitudinal side.

According to the first embodiment of the invention illustrated in FIGS. 9 to 11, the lower cavity 45 is positioned adjacent to the second longitudinal side 6 of the insulation material, as the upper cavity 44. This way, when a sandwich panel is positioned on a roof by overlapping the second longitudinal rib 21 of an adjacent panel with the first longitudinal rib 18 of the sandwich panel, the second longitudinal side of the insulation material remains accessible to the operator. The latter can thus easily open the cavity, if it has not been done at a previous step, and access the connector(s) to connect them to the electrical connector(s) of sandwich panels adjacent along the roof slope or to the grid. In particular, the casing of the lower cavity is positioned adjacent to the second longitudinal side. More particularly, a wall of the casing is positioned adjacent to the second longitudinal side. It can be a plain wall or a wall comprising an outlet for accessing the electrical connector(s). This wall can be in the plane of the second longitudinal side. In that case, this wall and, if applicable, the outlet for accessing the electrical connector(s) are not in contact with the insulation material. The lower cavity, in particular its casing, can be adjacent to the edge band 9. Preferably, the lower cavity is positioned, along the longitudinal axis X of the sandwich panel, between the first lower perforation 28 and the lower transverse side 8 of the insulation material. This position limits the length of cables needed to connect the photovoltaic active areas. More preferably, the lower cavity is adjacent to the lower transverse side 8 of the insulation material. It further limits the length of cables running between sandwich panels and facilitates the connections between panels.

In this embodiment, when the electrical connectors with a portion of cable are extracted from the lower cavity or when additional cables are connected to the electrical connectors, the cables should not prevent the sandwich panels from being assembled contiguously. Consequently, there are different ways to have the lower cavity open and/or to have the electrical connectors accessed from the lower cavity and to have the cables run.

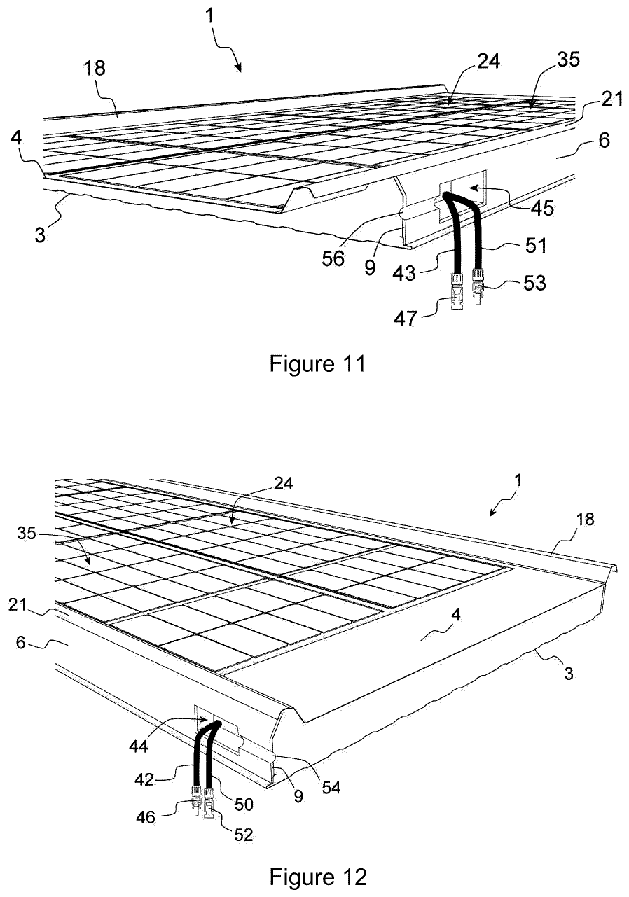

In one variant of the first embodiment illustrated in FIG. 11, the lower cavity adjacent to the second longitudinal side 6 is open along the second longitudinal side 6 of the insulation material, possibly through a cut in the insulation material and/or through a cut in the edge band 9 and/or through a cut in the casing of the lower cavity. Accordingly, the second longitudinal side of the insulation material comprises a lower cutout 56 extending from the lower cavity to the lower transverse side, so that the cable(s) can run in the lower cutout.

In another variant of the first embodiment where the lower cavity is adjacent to the second longitudinal side 6 and to the lower transverse side 8 of the insulation material, the lower cavity is open along this lower transverse side, possibly through a cut in the insulation material and/or through a cut in the cap 10 and/or through a cut in the casing of the lower cavity. In that case, the electrical connector(s) of a sandwich panel being positioned on the roof can be extracted from the lower cavity, connected to the electrical connector(s) of a sandwich panel positioned adjacently lower along the roof slope and retracted in the lower cavity when the two sandwich panels are positioned contiguously. Alternatively, if the lower cavity is open along both the lower transverse side and the second longitudinal side, the two panels can be positioned contiguously and then the electrical connector(s) can be connected while remaining in the lower cavity.

In another variant of the first embodiment, the lower cavity adjacent to the second longitudinal side 6 is open along the inner sheet 3, for example with a lower hole in the inner sheet, possibly through a cut in the insulation material and/or through a cut in the casing of the upper cavity. In this variant, the electrical connector(s) can be accessed from the inside of the building and/or from the side as they are at hand reach from the second longitudinal side. They do not prevent the sandwich panels from being assembled contiguously and they can be connected from the inside of the building. This variant is made easier if the lower cavity is adjacent to the inner sheet in addition to being adjacent to the second longitudinal side.

According to a second embodiment of the invention illustrated in FIGS. 13, 14 and 16, the upper cavity 44 is positioned adjacent to the inner sheet 3, in particular to the backside of the inner sheet. This way, when a sandwich panel is positioned on a roof, the cable(s) can be accessed from the inner sheet and the electrical connections can be done from the inside of the building. In particular, the casing of the upper cavity is positioned adjacent to the inner sheet. More particularly, a wall of the casing is positioned adjacent to the inner sheet. It can be a plain wall or a wall comprising an outlet for accessing the electrical connector(s). This wall can be in contact with the inner sheet. Preferably, the upper cavity is positioned along the longitudinal axis X of the sandwich panel between the first upper junction box 40 and the upper transverse side 7 of the insulation material. This position limits the length of cables needed to connect the photovoltaic active areas. More preferably, the upper cavity is positioned in the upper overlap area 23. It further limits the length of cables running between sandwich panels and facilitates the connections between panels. Alternatively, the upper cavity can be positioned adjacent to the first and/or second upper junction box or even plumb with the junction box. According to a variant of the invention, the junction box is inside the upper cavity, by being for example integrated in the upper cavity casing. It eases the installation of the electrical components on the backside of the outer sheet since the junction box and the upper cavity can be installed at once. The first and/or second upper cable and the first and/or second upper electrical connector can even be pre-installed in the upper cavity, before the latter is positioned on the backside of the outer sheet.

In this embodiment, when the electrical connectors with a portion of cable are extracted from the upper cavity or when additional cables are connected to the electrical connectors, the cables should not prevent the sandwich panels from being positioned on the building structure, in particular on the purlins 58. Consequently, there are different ways to have the upper cavity open and/or to have the electrical connectors accessed from the upper cavity and to have the cables run.

In one variant of the second embodiment illustrated in FIG. 16, the upper cavity 44 adjacent to the inner sheet 3 is open along the inner sheet 3, for example with an upper hole 55 in the inner sheet, possibly through a cut in the insulation material and/or through a cut in the casing of the upper cavity. In this variant, the electrical connector(s) can be accessed from the inside of the building. As the upper overlap area 23 is positioned on a purlin, the upper cavity, and thus the upper hole in the inner sheet, is preferably positioned away from the area intended for contact with the purlin. More preferably, it is positioned below the area intended for contact with the purlin. Alternatively or in addition, the inner sheet can comprise an upper groove 59 extending from the upper cavity to the upper transverse side, so that the cable(s) can run in the upper groove between the purlin and the inner sheet of the sandwich panel.

In another variant of the second embodiment where the upper cavity is adjacent to the inner sheet 3 and to the upper transverse side 7 of the insulation material, the upper cavity is open along this upper transverse side, possibly through a cut in the insulation material and/or through a cut in the cap 10 and/or through a cut in the casing of the upper cavity. In that case, the electrical connector(s) can be extracted from the upper cavity and connected to the electrical connector(s) of a sandwich panel being positioned adjacently higher along the roof slope and retracted in the upper cavity when the two sandwich panels are positioned contiguously.

According to the second embodiment of the invention illustrated in FIGS. 13 to 15, the lower cavity 45 is positioned adjacent to the inner sheet 3, in particular to the backside of the inner sheet, as the upper cavity 44. This way, when a sandwich panel is positioned on a roof, the cable(s) can be accessed from the inner sheet and the electrical connections can be done from the inside of the building. In particular, the casing of the lower cavity is positioned adjacent to the inner sheet. More particularly, a wall of the casing is positioned adjacent to the inner sheet. It can be a plain wall or a wall comprising an outlet for accessing the electrical connector(s). This wall can be in contact with the inner sheet. Preferably, the lower cavity is positioned along the longitudinal axis X of the sandwich panel between the first lower junction box 41 and the lower transverse side 8 of the insulation material. This position limits the length of cables needed to connect the photovoltaic active areas. More preferably, the lower cavity is positioned adjacent to the lower overlap area 22. It further limits the length of cables running between sandwich panels and facilitates the connections between panels. The lower cavity can also be positioned adjacent to the first and/or second lower junction box or even plumb with the junction box. According to a variant of the invention, the junction box is inside the lower cavity, by being for example integrated in the lower cavity casing. It eases the installation of the electrical components on the backside of the outer sheet since the junction box and the upper cavity can be installed at once. The first and/or second lower cable and the first and/or second lower electrical connector can even be pre-installed in the lower cavity, before the latter is positioned on the backside of the outer sheet.

In this embodiment, when the electrical connectors with a portion of cable are extracted from the lower cavity or when additional cables are connected to the electrical connectors, the cables should not prevent the sandwich panels from being positioned on the building structure, in particular on the purlins 58. Consequently, there are different ways to have the lower cavity open and/or to have the electrical connectors accessed from the lower cavity and to have the cables run.

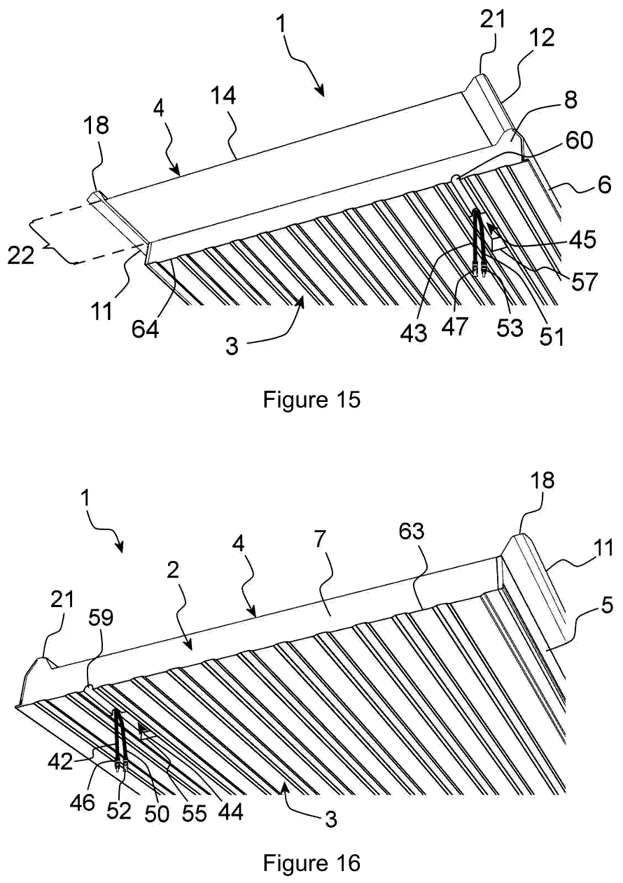

In one variant of the second embodiment illustrated in FIG. 15, the lower cavity 45 adjacent to the inner sheet 3 is open along the inner sheet 3, for example with a lower hole 57 in the inner sheet, possibly through a cut in the insulation material and/or through a cut in the casing of the upper cavity. In this variant, the electrical connector(s) can be accessed from the inside of the building. As the lower transverse side 8 of the insulation material is preferably positioned on a purlin, the lower cavity, and thus the lower hole in the inner sheet, is preferably positioned away from the area intended for contact with the purlin. More preferably, it is positioned above the area intended for contact with the purlin. Alternatively or in addition, the inner sheet can comprise a lower groove 60 extending from the lower cavity to the lower transverse side, so that the cable(s) can run in the lower groove between the purlin and the inner sheet of the sandwich panel.

In another variant of the second embodiment where the lower cavity is adjacent to the inner sheet 3 and to the lower transverse side 8 of the insulation material, the lower cavity is open along this lower transverse side, possibly through a cut in the insulation material and/or through a cut in the cap 10 and/or through a cut in the casing of the lower cavity. In that case, the electrical connector(s) from a sandwich panel being positioned on the roof can be extracted from the lower cavity, connected to the electrical connector(s) of a sandwich panel positioned adjacently lower along the roof slope and retracted in the lower cavity when the two sandwich panels are positioned contiguously.

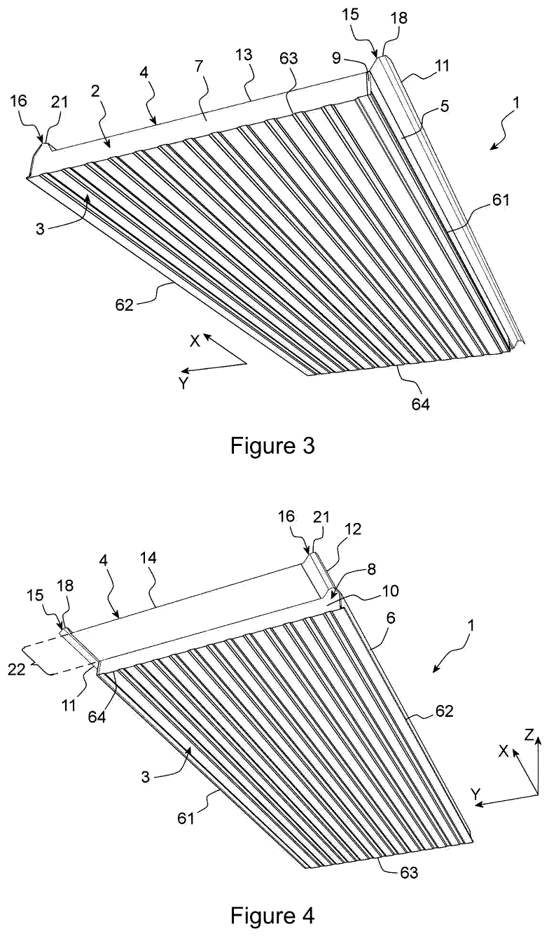

With reference to FIGS. 3 to 5, the sandwich panel 1 further comprises an inner sheet 3. It is a sheet of substantially rectangular shape, comprising a first longitudinal inner edge 61, a second longitudinal inner edge 62, an upper transverse inner edge 63, a lower transverse inner edge 64. The inner sheet is substantially a flat rectangle at the size of the insulation material. It can nevertheless be shaped notably along its edges to notably facilitate the interlocking of two adjacent panels and/or to increase its stiffness.

According to a preferred variant of the inner sheet, a first longitudinal inner flange 65 runs along the first longitudinal inner edge 61 and a second longitudinal inner flange 66 runs along the second longitudinal inner edge 62. The first longitudinal inner flange 65 and the second longitudinal inner flange 66 are connected by an inner central part 67. The later substantially lies down flat in plane P. According to a variant of the invention, the inner central part comprises longitudinal stiffeners to increase the stiffness of the metallic sheet.

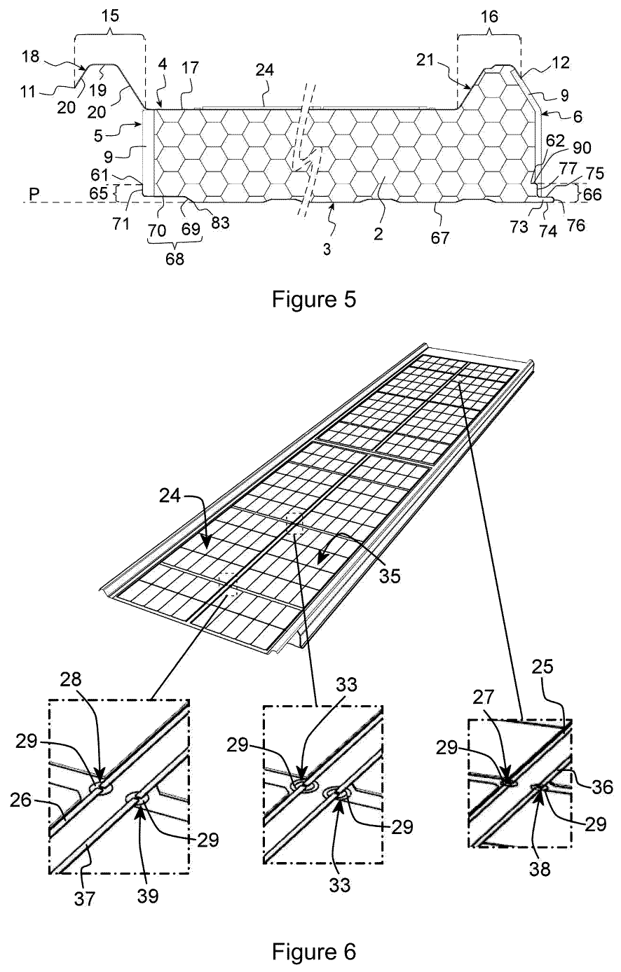

As illustrated in FIG. 5, in cross-section perpendicular to the longitudinal axis X, the first longitudinal inner flange 65 extends inwards from the first longitudinal extremity of the inner central part 67 and forms an inner edge rabbet 68 in the insulation material along the first longitudinal side 5 of the insulation material. The inner edge rabbet extends in parallel to plane P and inwards. Preferably, the inner edge rabbet comprises, successively and starting from the first longitudinal extremity of the inner central part, an inner riser 69 and a top portion 70. The inner riser can extend substantially perpendicular to the inner central part, i.e. perpendicular to plane P, or can be inclined towards the top portion. The latter can be parallel to plane P or slightly inclined towards the inner central part to facilitate the interlocking of two adjacent panels.

Preferably the first longitudinal inner flange 65 further comprises a first inner stiffener 71 extending from the inner edge rabbet 68, in particular from the top portion 70. According to one variant of the invention, the first inner stiffener extends substantially perpendicularly to the inner central part along the first longitudinal side 5 of the insulation material. It improves the sealing between two panels.

The first longitudinal inner flange 65 is on the same longitudinal side of the insulation material as the first longitudinal rib of the outer sheet, which projects from the longitudinal side of the insulation material, as illustrated in FIG. 5. It facilitates the lateral assembling of two adjacent panels. More preferably, the first longitudinal inner edge 61 is substantially plumb with the first longitudinal extremity 83 of the outer central part 17 of the outer sheet 4. In other words, the inner edge rabbet 68 is positioned underneath the outer central part 17 of the outer sheet 4.

The second longitudinal inner flange 66 extends from the second longitudinal extremity of the inner central part 67 by projecting from the second longitudinal side 6 of the insulation material and forming an inner tongue 73 extending substantially parallel to plane P and outwards. Preferably, the inner tongue is in the form of a U-shaped bend comprising a lower branch 74 and an upper branch 75 linked by a U-turn 76. More preferably, the branches 74 and 75 are parallel. More preferably, the radius of the U-turn is such that the space in-between the branches is filled with insulation material 2 which helps stiffening the inner tongue. According to another variant, the radius of the U-turn is such that the two branches are in contact with each other.

Preferably the second longitudinal inner flange 66 comprises a second inner stiffener 77 extending from the inner tongue 73, in particular from the upper branch 75. According to one variant of the invention, the second inner stiffener extends substantially perpendicularly to the inner central part 67 along the second longitudinal side 6 of the insulation material. It improves the sealing between two panels. According to one variant of the invention, the second inner stiffener 77 comprises a second inner wing 90 extending parallel to plane P and inwards into the insulation material 2. This helps stiffening the first inner flange.

The inner edge rabbet 68 and the inner tongue 73 have shapes that allow their interlocking when one sandwich panel is assembled with a sandwich panel laterally adjacent. Preferably, their shapes are substantially complementary and their dimensions are such that:
The height of the inner edge rabbet (measured along the vertical axis Z) is superior to the height of the inner tongue.
The width of the inner edge rabbet (measured along the transversal axis Y) is superior or equal to the width of the inner tongue.

Such interlocking of the inner edge rabbet and the inner tongue improves the resistance to wind suction of the envelope made of sandwich panels.

In a variant of the inner sheet, the shapes of the first longitudinal inner flange 65 and second longitudinal inner flange 66 are inverted.

From a manufacturing process perspective, there are mainly three ways of producing sandwich panels.

The first way is a discontinuous process in which the inner sheet and the outer sheet are first cut to size and shaped (or vice versa). In a first variant, they are then maintained in a mold at a given distance from each other and the gap between them is filled with a reaction mix that expands to form the insulation material. In a second variant, one of the sheets is positioned in a mold and covered by the insulation material, preferably in the form of slabs, also known as batts or lamellas. A layer of adhesive is applied between the sheet and the slabs of insulation material and another layer of adhesive is applied on the insulation material. Then the second sheet is positioned on the insulation material and the stack is pressed and heated to cure the adhesive.

The second way is a continuous process in which an inner facing and an outer facing are provided in the form of coils. The coils are wound off and the strips go, one above the other, through profiling stations where they are shaped. In a first variant, a reaction mix is then applied to the inside face of the lower strip or to the inside face of the upper strip and the two strips enter a double-belt conveyor. The latter comprises two continuous conveyor belts aligned one above the other, running parallel to one another and capable of absorbing or applying a certain amount of pressure to maintain the gap between the two strips. The gap between the two belts is adjustable, allowing the thickness of the panels to be adjusted. In the double-belt conveyor, the reaction mix expands and fills the gap between the two strips to form the insulation material. A side wall prevents lateral escape of the foam. Different panel designs and operating modes require an appropriate side seal in each case. The side wall can be in the form of an accompanying side sealing chain made of blocks. After the composite formed from the two strips and the insulation material has left the double-belt conveyor, the composite is cut to the desired length to obtain sandwich panels. In a second variant, a layer of adhesive is applied to the inside face of the lower strip and slabs of insulation material are positioned. Another layer of adhesive is applied on the insulation material or on the inside face of the upper strip. In the double-belt conveyor, the strips are pressed and the adhesive is cured. The other features of the first variant apply to the second variant.

The third way is a semi-continuous process. It differs from the continuous process in that only the inner facing is supplied in the form of a coil and enters the double-belt conveyor as a strip, in this case as the inner strip, preferably as the higher strip on the manufacturing line. The outer facing is in the form of sheets cut to size and shaped (or vice versa) at a previous step. The outer sheets are fed continuously, with no gaps, in the manufacturing line, preferably in place of the lower strip. Then, in the first variant, the reaction mix is applied to the inside face of the outer sheets or to the inside face of the upper strip and the inner strip and the outer sheets enter the double-belt conveyor. In the conveyor, the reaction mix reacts and expands to fill the gap between the inner strip and the outer sheets and thus forms the insulation material. In the second variant, the layers of adhesive are applied and the slabs of insulation material are positioned on the outer sheets and then, the inner strip and the outer sheets enter the double-belt conveyor where they are pressed. At the exit of the conveyor, the inner strip and the insulation material are cut depending on the length of the outer sheets to obtain sandwich panels.

The manufacture of the sandwich panel according to the invention will be described in relation to the discontinuous process and the semi-continuous process but the person ordinary skilled in the art can easily adapt other manufacturing methods of sandwich panels to manufacture the sandwich panel according to the invention.

At a first stage, the outer sheet 4 is prepared.

In a first step, the outer sheet is cut to length. Optionally, it is cut to length from a strip and then shaped or the strip is first shaped on a profiling line and then cut to length. The shaping step comprises the forming of the first longitudinal rib 18 and of the second longitudinal rib 21.

In a second step, anterior to or concomitant with or posterior to the first step, a first upper perforation 27 and a first lower perforation 28 are done in the outer central part 17. If applicable, a second upper perforation 38 and a second lower perforation 39 and/or by-pass perforations 33 are also done in the outer central part. Optionally, non-conductive grommets are positioned in, and possibly attached to, the upper and lower perforations.

In a third step, posterior to the first and second steps, a first photovoltaic active area 24 is positioned on the outer central part and preferably laminated. If applicable, a second photovoltaic active area 35 is also positioned on the outer central part at the same time and preferably laminated. In particular, positioning the photovoltaic active area comprises stacking the different components of the photovoltaic active area. In particular, during the positioning step, a first upper electrical conductor 25 is inserted in the first upper perforation and a first lower electrical conductor 26 is inserted in the first lower perforation. More particularly, non-conductive grommets 29 are inserted in the first upper and lower perforations. If applicable, a second upper electrical conductor 36 is inserted in the second upper perforation and a second lower electrical conductor 37 is inserted in the second lower perforation. Once the stack has been prepared, it is heated and pressed in a lamination device so that the films surrounding the solar cells fuse and embed them. At the end of this step, if the outer sheet has not been previously shaped, it is done so.

When the photovoltaic active area is laminated on the outer sheet, the latter does not comprise any part substantially protruding from the surface of the backside of the outer sheet, in particular from the surface of the backside of the outer central part. In particular, there is no part protruding over more than 2 mm below the surface of the backside of the outer sheet, or below the surface of the backside of the outer central part, more preferably over more than 1 mm. In other words, the surface of the backside of the outer central part, or the surface of the backside of the outer sheet, is substantially flat. Thanks to this design, the lamination of the photovoltaic active area can be efficiently performed on the outer sheet alone, without modifying existing lamination equipment to accommodate parts protruding from the surface of the backside of the outer sheet.

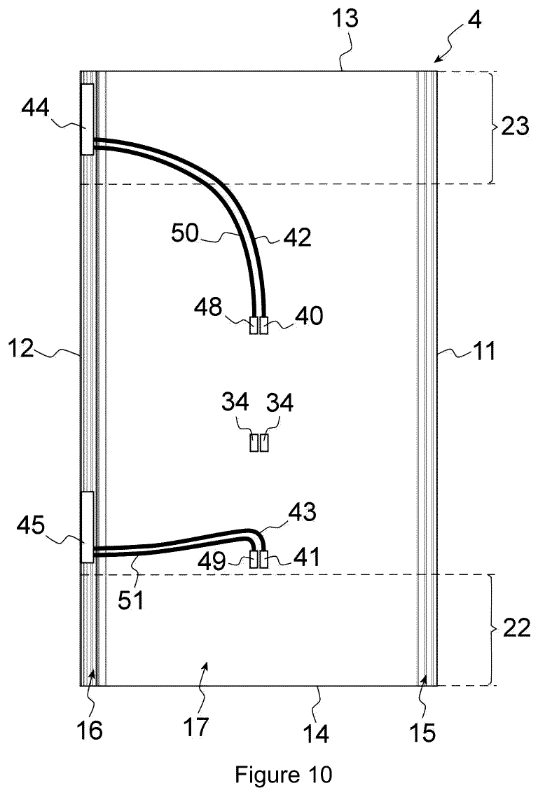

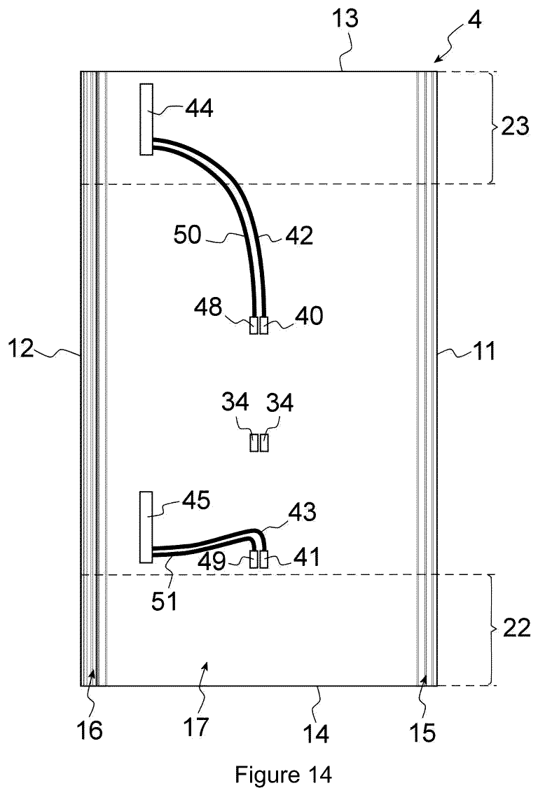

In a fourth step, posterior to the third step, the outer sheet is positioned upside down and its backside is equipped with a first upper cable 42, a first upper electrical connector 46, a first lower cable 43, a first lower electrical connector 47, an upper cavity 44 and a lower cavity 45, as illustrated in FIGS. 10 and 14. Optionally, it is also equipped with a first upper junction box 40 and a first lower junction box 41. If applicable, it is further equipped with a second upper cable 50, a second upper electrical connector 52, a second lower cable 51 and a second lower electrical connector 53 and/or by-pass diodes 34, as illustrated in FIGS. 10 and 14. Optionally, it is also equipped with a second upper junction box 48 and a second lower junction box 49. The junction boxes are preferably positioned substantially plumb with the perforations. The electrical conductors are electrically connected to one end of a cable, possibly inside the junction boxes. The other end of the cables is inserted in a cavity and electrically connected to an electrical connector (or vice versa).

The upper cavity is positioned in the upper half of the outer sheet, facing the backside of the outer sheet, and the lower cavity is positioned in the lower half of the outer sheet outside of the lower overlap area, facing the backside of the outer sheet.

The upper cavity is preferably attached, directly or indirectly, to the backside of the outer sheet and the lower cavity is preferably attached, directly or indirectly, to the backside of the outer sheet.

According to a first variant, the upper cavity and the lower cavity are positioned along the second longitudinal outer edge 12. This way, at the end of the manufacturing process, the cavities are adjacent to the second longitudinal side of the insulation material. The upper and lower cavities, in particular their casings, can be directed attached, for example by gluing, to the backside of the outer sheet or they can be attached to one shim 82 or a plurality of shims, themselves attached to the backside of the outer sheet, as illustrated in FIGS. 9 and 13. With the shim(s), the position along the vertical axis Z of the cavities in the insulation material can be adjusted, depending on the thickness of the insulation material. The shim(s) can also facilitate the positioning of the upper and lower cavity on one lateral wing 20 of the second longitudinal rib 21 of the outer sheet. As an alternative to the attachment to the backside of the outer sheet, in the discontinuous process, the upper cavity and/or lower cavity can be attached to an edge band 9 prepositioned, previously or concomitantly, along the second longitudinal outer edge 12. It facilitates the positioning of the cavity along the edge band during the laying of the insulation.

According to a second variant, the upper cavity and the lower cavity are positioned on the backside of the outer sheet. This way, at the end of the manufacturing process, the cavities are adjacent to the inner sheet. To do so, the upper cavity and the lower cavity are preferably positioned on shims 82. The shim thickness (taken along the vertical axis Z) is adjusted so that the sum of the shim thickness and the cavity thickness equal the thickness of the insulation material of the sandwich panel. Alternatively, the cavity has the thickness of the insulation material and is directly positioned on, and attached to, the outer sheet.

At a second stage, posterior to the first stage, the outer sheet is provided.

At a third stage, anterior to or concomitant with or posterior to the second stage, the inner sheet is provided. In a first variant corresponding to a discontinuous process, the inner sheet cut to size and possibly shaped is provided. In a second variant corresponding to a semi-continuous process, the inner sheet is provided in the form of a strip, possibly shaped.

At a fourth stage, posterior to the second stage and anterior to or concomitant with or posterior to the third stage, insulation is put in place. It can be put in place in the form of a reaction mix applied on the backside of the outer sheet or injected between the inner and outer sheets or in the form of slabs of insulation material 2 applied on the backside of the outer sheet. In the case of the reaction mix, it expands to form the insulation material 2. The outer sheet is preferably positioned upside down. In that case, if it has not already been positioned upside down at the first stage, it is positioned upside down before the insulation is put in place.

At a fifth stage, posterior to the second stage, concomitant with or posterior to the third stage, and anterior to or concomitant with or posterior to the fourth stage, the inner sheet is maintained at a given distance from the outer sheet. In particular, it is positioned so that, at the end of the manufacturing process, the upper and lower cavities are either both adjacent to the second longitudinal side of the insulation material or both adjacent to the inner sheet. The distance between the inner sheet and the outer sheet can be maintained in the mold, in a press or in a double-belt conveyor. The outer sheet is preferably positioned upside down. In that case, if it has not already been positioned upside down at the first stage, it is positioned upside down before the inner sheet is positioned. The given distance corresponds to the set thickness of the sandwich panel.

The fourth and fifth stages are detailed below in relation to the discontinuous process and semi-continuous process. Overall, during these two stages, insulation is put in place and the inner sheet is maintained at a given distance from the outer sheet, or vice versa.

As for the discontinuous process, in a first variant, the outer sheet and the inner sheet are positioned in a mold at a given distance from each other. The outer sheet is preferably positioned upside down at the bottom of the mold and the inner sheet at the top of the mold. The distance between the inner sheet and the outer sheet can be adjusted with shims. The mold maintains the distance between the inner sheet and the outer sheet. Edge bands 9 are preferably added along the longitudinal sides of the mold between the inner sheet and the outer sheet, unless an edge band has already been positioned along the second longitudinal outer edge at the previous step. In other words, the edge bands are preferably positioned along the first longitudinal inner edge and the second longitudinal inner edge of the inner sheet. Caps are preferably positioned along the transverse sides of the mold, between the inner sheet and the outer sheet. In other words, the caps are preferably positioned along the upper transverse inner edge 63 and along the lower transverse inner edge 64 of the inner sheet, between the inner sheet and the outer sheet.

Then, a reaction mix is injected in the mold between the inner sheet and the outer sheet. The reaction mix reacts and expands to fill the gap between the inner sheet and the outer sheet and thus forms the insulation material. The expansion of the reaction mixture can be done in a press or in a conveyor, possibly a double-belt conveyor.

In a second variant of the discontinuous process, the outer sheet is positioned upside down in a mold and slabs of insulation material 2 are positioned on the outer sheet. A layer of adhesive is applied between the outer sheet and the slabs of insulation material and another layer of adhesive is applied on the insulation material. Edge bands 9 and caps 10 can be added as described in relation to the first variant. Then the inner sheet is positioned on the insulation material and maintained at a given distance from the outer sheet. The stack is pressed and heated to cure the adhesive. The pressing and heating can be done in a press or in a conveyor, possibly a double-belt conveyor.

As for the semi-continuous process, the inner sheet enters the double-belt conveyor as an inner strip, possibly shaped. The inner strip is namely the higher strip on the manufacturing line. The outer sheets are fed continuously, with no gaps, in the manufacturing line. They replace the second strip on the manufacturing line, namely the lower strip. Each outer sheet is thus part of a continuous feeding of the manufacturing line.

In a first variant of the semi-continuous process, the outer sheets are positioned upside down, if not already in that position, and the reaction mix is applied to their backside or to the backside of the inner strip. The inner strip and the outer sheets enter the double-belt conveyor where the distance between them is maintained by the double-belt conveyor. In the latter, the reaction mix reacts, expands and fills the gap between the inner strip and the outer sheet to form the insulation material. Edge bands 9 are preferably positioned along the first longitudinal inner edge and the second longitudinal inner edge of the inner sheet, unless edge bands have already been positioned at the previous step. The edge bands are preferably coils wound off in the form of strips which enter the double-belt conveyor.

In a second variant of the semi-continuous process, the outer sheets are positioned upside down, if not already in that position, and slabs of insulation material 2 are positioned on the outer sheet. A layer of adhesive is applied between the outer sheet and the slabs of insulation material and another layer of adhesive is applied on the insulation material. Then, the inner strip and the outer sheets enter the double-belt conveyor where the distance between them is maintained by the double-belt conveyor. In the latter the stack is pressed and heated to cure the adhesive.

Once the insulation material has been formed, the sandwich panel manufactured through the discontinuous process can be removed from the mold. As for the semi-continuous process, at the exit of the conveyor, the inner strip and the insulation material are cut depending on the length of the outer sheets to obtain the sandwich panels.

Once a sandwich panel has been manufactured, the upper cavity 44 can be opened to give access to the first upper electrical connector 46, and, if applicable, to the second upper electrical connector 52. Similarly, the lower cavity 45 can be opened to give access to the first lower electrical connector 47, and, if applicable, to the second lower electrical connector 53. This is illustrated in FIGS. 11, 12, 15 and 16.

According to a first variant where the upper cavity and the lower cavity are positioned adjacent to the second longitudinal side of the insulation material, each cavity can be opened by means of a cut in the second longitudinal side. Depending on the nature and position of the cavity, the cut can be done through different materials. If the cavity comprises a casing having a plain wall adjacent to the second longitudinal side, the cut is done in the insulation material and in the casing. If a plain wall of the casing is in the plane of the second longitudinal side, there is no cut through the insulation material. If the wall of the casing in the plane of the second longitudinal side has already an outlet for accessing the electrical connector(s), there is no cut through the casing. If the longitudinal side is covered by an edge band, the cut is done in the edge band. The cut can be done with any appropriate tool, such as, for example, a cutter, a saw or a chisel.

According to a second variant where the upper cavity and the lower cavity are positioned adjacent to the inner sheet, each cavity can be opened by means of a cut in the inner sheet. In the variant where the inner sheet comprises an upper groove 59 and/or a lower groove 60, the cut is preferably made adjacent to the groove or in the groove. Depending on the nature and position of the cavity, the cut can be done through different materials. If the cavity comprises a casing having a plain wall adjacent to the inner sheet, the cut is done in the inner sheet, in the insulation material and in the casing. If a plain wall of the casing touches the inner sheet, there is no cut through the insulation material. If the wall of the casing touching the inner sheet has already an outlet for accessing the electrical connector(s), there is no cut through the casing. The cut can be done with any appropriate tool, such as, for example, a drill.

The opening of the upper and lower cavity can be done right after the manufacturing of the sandwich panels or later on. To limit the operations during installation of the sandwich panels on a roof and to better control the quality of the cuts, the latter are preferably done at the manufacturing site.

With reference to FIGS. 11 and 12, according to the variant where the upper cavity and the lower cavity are positioned adjacent to the second longitudinal side of the insulation material, once a sandwich panel has been manufactured, an upper cutout 54 and/or a lower cutout 56 can be done in the second longitudinal side of the insulation material. It is preferably done at the same time as the cuts for the opening of the upper and lower cavity. The cutouts can be done with any appropriate tool, such as, for example, a cutter, a chisel, or a grooving machine.

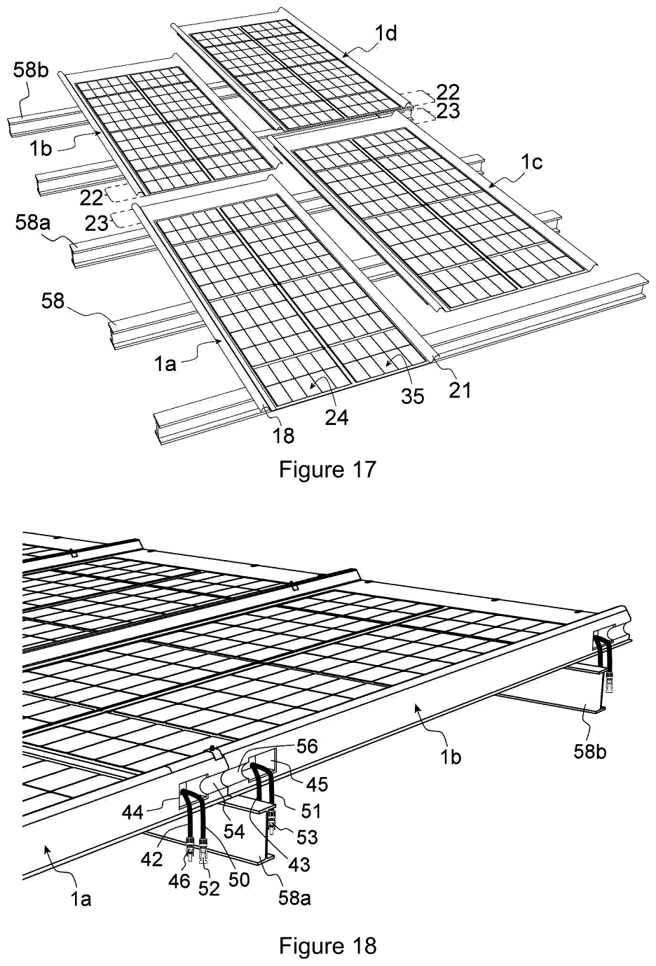

Once sandwich panels have been manufactured, they can be shipped to a construction site for assembling of a building envelope on a building structure. With reference to FIGS. 17, 18 and 20, the process for the assembling of the building envelope comprises a first step where a first sandwich panel 1a is fastened to the building structure. In particular, it is fastened to a purlin 58. More particularly, the lower half of the first sandwich panel is fastened to a lower purlin. In particular, the upper half of the first sandwich panel rests on a first upper purlin 58a. More particularly, the upper overlap area 23 of the first sandwich panel rests on the first upper purlin.

In a second step, a second sandwich panel 1b is positioned on the building structure, adjacent to the first sandwich panel along the building slope, so that its lower overlap area 22 covers the upper overlap area 23 of the first sandwich panel. In particular, the lower half of the second sandwich panel rests on the first upper purlin. In particular, the upper half of the second sandwich panel rests on a second upper purlin 58b, positioned higher than the first upper purlin. More particularly, the upper overlap area 23 of the second sandwich panel rests on the second upper purlin. The second sandwich panel is fastened to the building structure. In particular, it is fastened to the first upper purlin. More particularly, the lower overlap area of the second sandwich panel is fastened to the first upper purlin, concomitantly with the fastening of the upper overlap area of the first sandwich panel to the first upper purlin. Panels 1c and 1d then can be added as shown in FIG. 17.

In a third step, the first upper electrical connector 46 of the first sandwich panel is connected to the first lower electrical connector 47 of the second sandwich panel. This step can take place right after the fastening of the second sandwich panel. It can also take place once all the sandwich panels of a row have been positioned and fastened. In the case in which the upper and lower cavities are adjacent to the inner sheet, it can also take place once all the sandwich panels of the roof (or roof side) have been positioned and fastened. In this latter case, an electrician does not need to be present on the roof during installation of the sandwich panels.

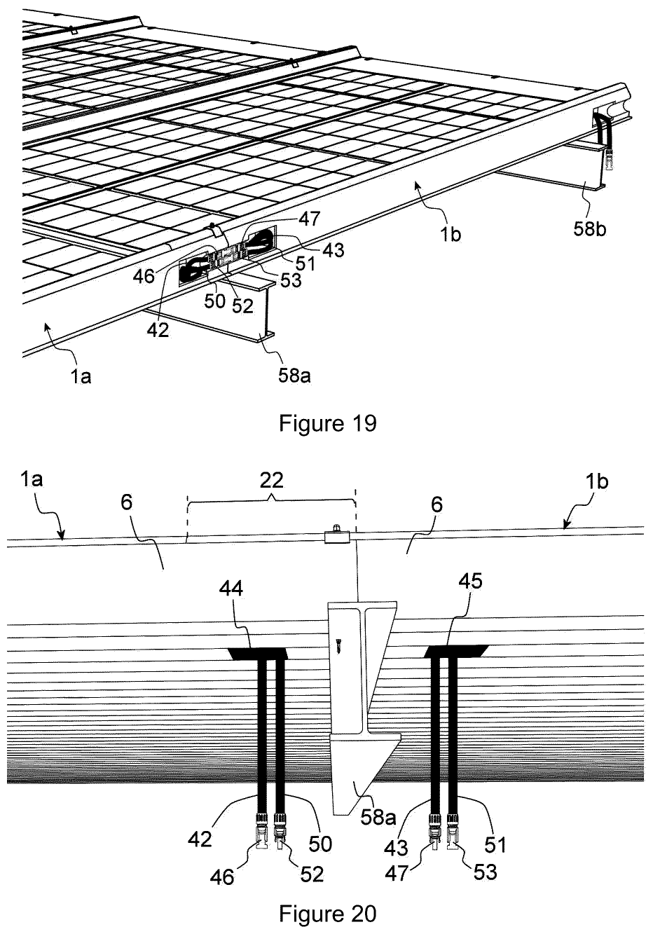

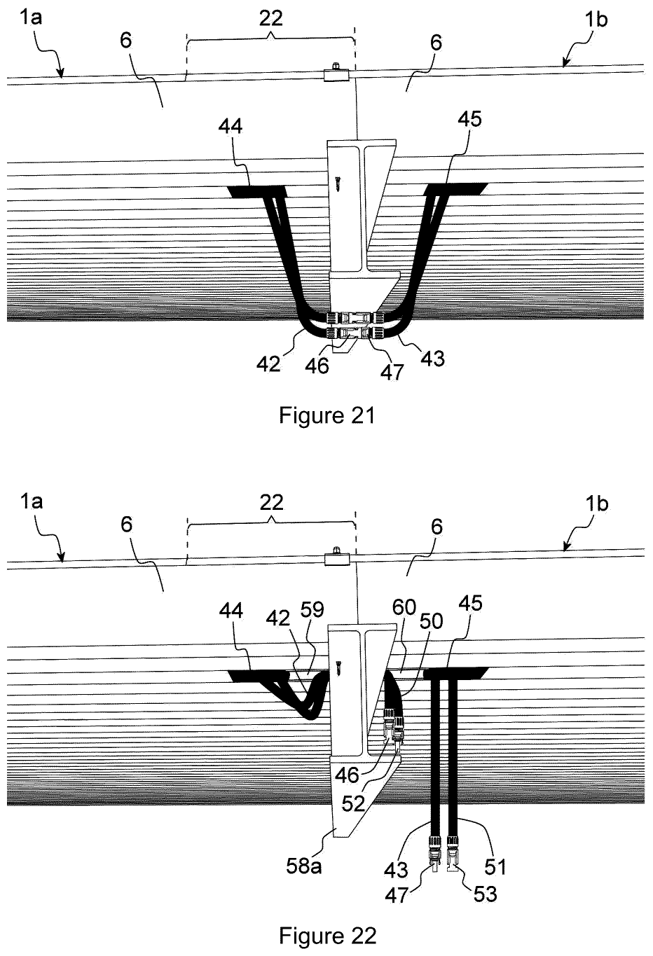

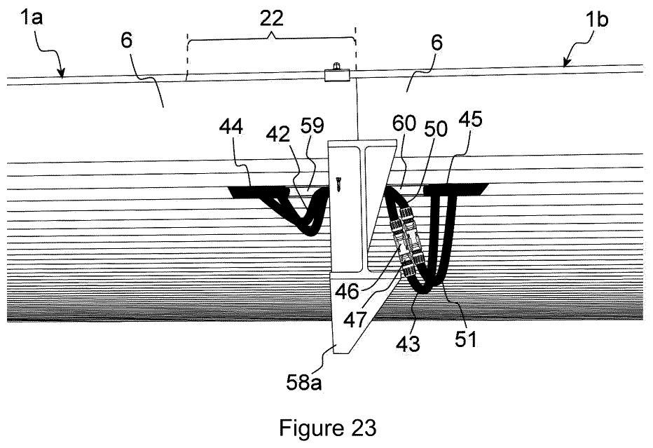

According to a first variant, the first upper electrical connector 46 of the first sandwich panel is extracted from the upper cavity 44. If the upper cavity has not been opened at a previous step, it is first opened. The first lower electrical connector 47 of the second sandwich panel is also extracted from the lower cavity. If the lower cavity has not been opened at a previous step, it is first opened. In the case in which the upper and lower cavities are adjacent to the second longitudinal edge, as illustrated in FIGS. 18 and 19, the first upper electrical connector 46 and part of the first upper cable 42 of the first sandwich panel are preferably inserted in the upper cutout 54 of the first sandwich panel and the first lower electrical connector and part of the first lower cable 43 of the second sandwich panel are preferably inserted in the lower cutout 56 of the second sandwich panel. In the case in which the upper and lower cavities are adjacent to the inner sheet, as illustrated in FIGS. 20 and 21, the first upper electrical connector and part of the first upper cable of the first sandwich panel can go around part of the purlin and the first lower electrical connector and part of the first lower cable of the second sandwich panel can go around the rest of the purlin. Alternatively, as illustrated in FIGS. 22 and 23, the first upper electrical connector and part of the first upper cable are inserted in the upper groove 59 of the inner sheet of the first sandwich panel, and/or the first lower electrical connector and/or part of the first lower cable of the second sandwich panel are inserted in the lower groove 60 of the inner sheet of the second sandwich panel.

If applicable, the second upper electrical connector 52 of the first sandwich panel and the second lower electrical connector 53 of the second sandwich panel are connected similarly.

According to a second variant, the first upper electrical connector of the first sandwich panel is left in the upper cavity (opened at a previous step) and the first lower electrical connector of the second sandwich panel is left in the lower cavity (opened at a previous step). The first upper electrical connector of the first sandwich panel is thus connected to the first lower electrical connector of the second sandwich panel with the help of an additional connection cable. In the case in which the upper and lower cavities are adjacent to the second longitudinal edge, the connection cable is preferably inserted in the upper cutout 54 of the first sandwich panel and in the lower cutout 56 of the second sandwich panel. In the case in which the upper and lower cavities are adjacent to the inner sheet, the connection cable can go around the purlin. Alternatively, it is inserted in the upper groove 59 of the inner sheet of the first sandwich panel and the lower groove 60 of the inner sheet of the second sandwich panel.

If applicable, the second upper electrical connector 52 of the first sandwich panel and the second lower electrical connector 53 of the second sandwich panel are connected similarly.

What is claimed is:

1-17. (canceled)

18. A sandwich panel, for a building envelope, comprising:
an inner sheet, an outer sheet and an insulation material sandwiched between the inner sheet and the outer sheet, the insulation material having a first longitudinal side, a second longitudinal side, an upper transverse side and a lower transverse side, the sandwich panel having an upper half and a lower half,
the outer sheet comprising:
a first longitudinal outer flange including a first longitudinal rib projecting from the first longitudinal side of the insulation material,
an outer central part extending from the first longitudinal rib, including:
a first upper perforation through which a first upper electrical conductor runs,
a first lower perforation through which a first lower electrical conductor runs,
a first photovoltaic active area positioned on the outer central part and electrically connected to the first upper electrical conductor and to the first lower electrical conductor,
a second longitudinal outer flange extending from the outer central part and comprising a second longitudinal rib, the first longitudinal rib and the second longitudinal rib having shapes allowing the overlapping of the first longitudinal rib on the second longitudinal rib,
a backside of the outer sheet comprising:
a first upper cable connecting the first upper electrical conductor to a first upper electrical connector positioned in an upper cavity,
a first lower cable connecting the first lower electrical conductor to a first lower electrical connector positioned in a lower cavity, the first lower electrical connector and the first upper electrical connector being corresponding male and female connectors,
the upper cavity being positioned within the insulation material in the upper half of the sandwich panel and adjacent to either the second longitudinal side of the insulation material or the inner sheet so that the first upper electrical connector can be accessed from the upper cavity,
the lower cavity being positioned within the insulation material in the lower half of the sandwich panel and adjacent to either the second longitudinal side of the insulation material or the inner sheet so that the first lower electrical connector can be accessed from the lower cavity.

19. The sandwich panel as recited in claim 18 wherein the upper cavity is open along the second longitudinal side of the insulation material or along the upper transverse side of the insulation material or along the inner sheet.

20. The sandwich panel as recited in claim 18 wherein the lower cavity is open along the second longitudinal sid of the insulation material or along the lower transverse side of the insulation material and/or along the inner sheet.

21. The sandwich panel as recited in claim 18 wherein the upper cavity is open along the second longitudinal side of the insulation material through a cut in the insulation material or through a cut in an edge band covering the second longitudinal side or through a cut in a wall of the upper cavity.

22. The sandwich panel as recited in claim 18 wherein the upper cavity is open along the inner sheet through an upper hole in the inner sheet.

23. The sandwich panel as recited in claim 18 wherein the lower cavity is open along the second longitudinal sideof the insulation material through a cut in the insulation material or through a cut in an edge band covering the second longitudinal side or through a cut in a wall of the lower cavity.

24. The sandwich panel as recited in claim 18 wherein the lower cavity is open along the inner sheet through a lower hole in the inner sheet.

25. The sandwich panel as recited in claim 18 wherein each of the upper cavity and the lower cavity is delimited by a casing embedded in the insulation material.

26. The sandwich panel as recited in claim 18 wherein:
the outer central part further includes:
a second upper perforation through which a second upper electrical conductor runs,
a second lower perforation through which a second lower electrical conductor runs,
the outer sheet further comprises a second photovoltaic active area positioned on the outer central part and electrically connected to the second upper electrical conductor and to the second lower electrical conductor,
the backside of the outer sheet further comprises:
a second upper cable connecting the second upper electrical conductor to a second upper electrical connector positioned in the upper cavity,
a second lower cable connecting the second lower electrical conductor to a second lower electrical connector positioned in the lower cavity, the second lower electrical connector and second upper electrical connector being corresponding male and female connectors.

27. The sandwich panel as recited in claim 26 wherein the first upper electrical connector and the second upper electrical connector are corresponding male and female connectors and wherein the first lower electrical connector and the second lower electrical connector are corresponding male and female connectors.

28. A sandwich panel, for a building envelope, comprising:
an inner sheet, an outer sheet and an insulation material sandwiched between the inner sheet and the outer sheet, the insulation material having a first longitudinal side, a second longitudinal side, an upper transverse side and a lower transverse side, the sandwich panel having an upper half and a lower half,
the outer sheet comprising:
a first longitudinal outer flange including a first longitudinal rib projecting from the first longitudinal side of the insulation material,
an outer central part extending from the first longitudinal rib, including:
a first upper perforation through which a first upper electrical conductor runs,
a first lower perforation through which a first lower electrical conducto runs,
a first photovoltaic active area positioned on the outer central part and electrically connected to the first upper electrical conductor and to the first lower electrical conductor,
a second longitudinal outer flange extending from the outer central part and comprising a second longitudinal rib, the first longitudinal rib and the second longitudinal rib having shapes that allow the overlapping of the first longitudinal rib on the second longitudinal rib,
a backside of the outer sheet comprising:
a first upper cable running from the first upper electrical conductor, through at least an upper cavity and either a cut in the second longitudinal side of the insulation material or an upper hole in the inner sheet, up to a first upper electrical connecto,
a first lower cable running from the first lower electrical conductor, through at least to a lower cavit and either a cut in the second longitudinal side of the insulation material or a lower hole in the inner sheet, up to a first lower electrical connector, the first lower electrical connector and the first upper electrical connector being corresponding male and female connectors,
the upper cavity being positioned within the insulation material in the upper half of the sandwich panel and adjacent to either the second longitudinal side of the insulation material or the inner sheet,
the lower cavity being positioned within the insulation material in the lower half of the sandwich panel and adjacent to either the second longitudinal side of the insulation material or the inner sheet.

29. A process for manufacturing a sandwich panel, the process comprising:
providing an outer sheet comprising:
an outer central part including:
a first upper perforation through which a first upper electrical conductor runs, and
a first lower perforation through which a first lower electrical conductor runs,
a first photovoltaic active area positioned on the outer central part and electrically connected to the first upper electrical conductor and to the first lower electrical conductor,
backside of the outer sheet comprising:
a first upper cable connecting the first upper electrical conductor to a first upper electrical connector positioned in an upper cavity,
a first lower cable connecting the first lower electrical conductor to a first lower electrical connector positioned in a lower cavity, the first lower electrical connector and the first upper electrical connector being corresponding male and female connectors,
the upper cavity being positioned in the upper half of the outer sheet,
the lower cavity being positioned in the lower half of the outer sheet outside of the lower overlap area,
providing an inner sheet,
putting insulation in place, and
maintaining the inner sheet at a given distance from the outer sheet.

30. The process as recited in claim 29 wherein the inner sheet is provided cut to size and shaped, wherein the outer sheet and the inner sheet are positioned in a mold at the given distance from each other and wherein a reaction mix is injected in the mold between the inner sheet and the outer sheet so that the reaction mix reacts, expands to fill the gap between the inner sheet and the outer sheet and forms the insulation material.

31. The process as recited in claim 29 wherein the inner sheet is provided in the form of an inner strip entering a double-belt conveyor of a manufacturing line, wherein the outer sheet is part of a continuous feeding of the manufacturing line in outer sheets and wherein a reaction mix is applied to the backside of the outer sheet or to the backside of the inner strip so that the reaction mix reacts, expands in the double-belt conveyor to fill the gap between the inner strip and the outer sheet and forms the insulation material.

32. The process as recited in claim 29 further comprising, after filling the space with the insulation material, opening the upper cavity to give access to the first upper electrical connector and opening the lower cavity to give access to the first lower electrical connector.

33. The process as recited in claim 29 further comprising, before providing the outer shee, preparing the outer sheet according to the following steps:
the outer sheet is cut to length from a strip,
the first upper perforation and the first lower perforation are done in the outer central par,
the first photovoltaic active area is positioned on the outer central part,
the backside of the outer sheet is equipped with the first upper cable, the first upper electrical connector, the first lower cable, the first lower electrical connector, the upper cavity and the lower cavity.

34. A process for the assembling of a building envelope on a building structure, comprising:
providing a first and a second sandwich panel as recited in claim 18, the outer sheet of the first sandwich panel further comprising an upper transverse outer edge bordering an upper overlap area and the outer sheet of the second sandwich panel further comprising a lower transverse outer edge extending beyond the lower transverse side of the insulation material to form a lower overlap area, the upper overlap area and the lower overlap area having shapes that allow the overlapping of the lower overlap area on the upper overlap area,
(ii) fastening the first sandwich panel to the building structure,
(iii) positioning the second sandwich panel so that its lower overlap area covers the upper overlap area of the first sandwich panel and fastening the second sandwich panel to the building structure, and
(iv) connecting the first upper electrical connector of the first sandwich panel to the first lower electrical connector of the second sandwich panel.

35. A process for the assembling of a building envelope on a building structure, comprising:
providing a first and a second sandwich panel as recited in claim 28, the outer sheet of the first sandwich panel further comprising an upper transverse outer edge bordering an upper overlap area and the outer sheet of the second sandwich panel further comprising a lower transverse outer edge extending beyond the lower transverse side of the insulation material to form a lower overlap area, the upper overlap area and the lower overlap area having shapes that allow the overlapping of the lower overlap area on the upper overlap area,
(ii) fastening the first sandwich panel to the building structure,
(iii) positioning the second sandwich panel so that its lower overlap area covers the upper overlap area of the first sandwich panel and fastening the second sandwich panel to the building structure, and
(iv) connecting the first upper electrical connector of the first sandwich panel to the first lower electrical connector of the second sandwich panel.
